(19) United States
(12) Patent Application Publication
(10) Pub. No.: US 2013/0004656 A1
(43) Pub. Date: Jan. 3, 2013

(54) APPARATUS AND METHOD TO SEPARATE CARRIER LIQUID VAPOR FROM INK

(75) Inventors: Jianglong CHEN, San Jose, CA (US); Elias MARTINEZ, San Jose, CA (US); Alexander Sou-Kang KO, Santa Clara, CA (US); Ian MILLARD, Menlo Park, CA (US); Eliyahu VRONSKY, Los Altos, CA (US); Conor F. MADIGAN, San Francisco, CA (US)

(73) Assignee: KATEEVA, INC., Menlo Park, CA (US)

(21) Appl. No.: 13/539,492

(22) Filed: Jul. 1, 2012

Related U.S. Application Data
(60) Provisional application No. 61/504,051, filed on Jul. 1, 2011.
(60) Provisional application No. 61/651,847, filed on May 25, 2012.

(51) Int. Cl. H05B 33/10; B05C 5/02

(52) U.S. Cl. 427/66; 118/63; 118/58

(57) ABSTRACT

Systems, apparatuses, and methods are provided that include or use a chuck, an inkjet printhead, and a gas knife to form film layers on a substrate, which have uniform feature dimensions and which avoid pile-up of inkjet ink. In some systems, a gas movement device is used instead of a gas knife. The systems, apparatus, and methods can be used to print layers on a substrate, which are used in an organic light-emitting device.

### CROSS-REFERENCE TO RELATED APPLICATIONS

The present application claims the benefit of U.S. Provisional Patent Applications Nos. 61/504,051, filed Jul. 1, 2011, and 61/651,847, filed May 25, 2012, both of which are incorporated herein in their entireties by reference. The present application also incorporates herein by reference in its entirety U.S. Provisional Patent Application No. 61/625,659, filed Apr. 17, 2012.

### FIELD

The present teachings relate to methods, apparatuses, and systems to separate carrier liquid vapors from ink during printing of inks onto substrates in the manufacture of a variety of products, for example, organic light-emitting devices.

### BACKGROUND

The manufacture of organic light-emitting devices (OLEDs) involves a high degree of accuracy to achieve products that function properly and meet customer expectations. Printing of organic materials onto substrates to form pixels in such devices presents various challenges. The goal is to deposit organic material in the right locations on a substrate with a uniform deposition of material at those locations. This goal is applicable to printing techniques generally, for example, thermal printing and inkjet printing. When OLEDs thus produced fail to meet design expectations, it can be difficult to trace the cause of the failure to a particular source. Even if printing is isolated as the cause of a failure, it can often not be determined what aspect of the printing is responsible, let alone how to fix the problem.

U.S. Patent Application Publications US 2008/0308037 A1, US 2008/0311307 A1, US 2010/0171780 A1, and US 2010/0188457 A1 describe thermal printing apparatus that include a transfer surface for depositing an organic material in the form of an ink onto a substrate, as a film. U.S. Patent Application Publication No. US 2011/0293818 A1 describes a conditioning unit to purge material that is not part of the deposited film, e.g., carrier liquid from the ink. The conditioning unit can be a heat and/or gas source, and can transmit radiation, convective heat, or conductive heat to the transfer surface. In various circumstances, heat alone, however, may not necessarily sweep the carrier liquid vapor away, and a gas may simply sweep it to a different part of the apparatus. In such circumstances, the carrier liquid vapor may not be sufficiently removed and may recondense, for example, at a different location of the transfer surface or at a different part of the deposition system. Recondensation can cause a build-up of undesirable material in the apparatus. Such build-up on the transfer surface can lead to a transfer of carrier liquid to the desired substrate, causing contamination or re-solubilization of the deposited film.

### SUMMARY OF VARIOUS EMBODIMENTS

According to various embodiments of the present teachings, a substrate printing system is provided that comprises a chuck, an inkjet printhead, and a gas knife. The chuck comprises a top surface configured to hold a substrate. The inkjet printhead is configured for inkjet printing onto a print surface of a substrate held by the chuck. The gas knife comprises an inlet for receiving pressurized gas from a pressurized gas source, and an outlet slot having a length and being configured to direct pressurized gas, from the gas knife, in the form of a sheet flow toward the top surface of a substrate held by the chuck. The inkjet printhead can be in fluid communication with a supply of ink. The ink can be an inkjet ink and can comprise a carrier fluid or liquid and film-forming organic material dissolved or suspended in the carrier fluid. The film-forming organic material can be useful for forming a functional layer of an organic light-emitting device. In some embodiments, a substrate is held by the chuck and the substrate comprises at least two rows of pixel banks. Each pixel bank can be configured to fence-in organic material that, when dried, can form a pixel for an organic light-emitting device. Each row of pixel banks can have a length and each pixel bank can have a length and a width that is shorter than the length. In some embodiments, the lengths of the pixel banks in each row are arranged substantially perpendicular to the length of the respective row. The length of the outlet slot can be oriented substantially parallel to the length of each pixel bank and substantially perpendicular to the length of each row. In other embodiments the length of the outlet slot is oriented substantially perpendicular to the length of each pixel bank and substantially parallel to the length of each row.

According to various embodiments, the substrate printing system can comprise an evacuation port and a vacuum source in fluid communication with the evacuation port. The evacuation port can be positioned relative to the gas knife such that a sheet flow of gas produced by the gas knife is sucked away through the evacuation port. The evacuation port can be mounted adjacent to the inkjet printhead and the evacuation port and the inkjet printhead can be configured to move in tandem relative to the top surface of the chuck.

In some embodiments, a substrate can be positioned on the top surface of the chuck and the substrate can comprise a top surface, a lateral edge, a length, and a width, wherein the gas knife is spaced from the lateral edge by a first distance. The first distance can be at least twice the length of the substrate, and the length of the substrate can be oriented substantially perpendicular to the length of the outlet slot. In some cases the first distance can be at least twice the width of the substrate and the width of the substrate can be substantially perpendicular to the length of the outlet slot.

In some embodiments, the substrate printing system is enclosed in an enclosure such that the enclosure contains the chuck, the inkjet printhead, and the gas knife. The enclosure can comprise an inert atmosphere and a circulation system configured to generate and maintain such an atmosphere. The inert atmosphere can be a nitrogen gas atmosphere or the like.

The substrate printing system can also comprise a printhead actuator configured to move the inkjet printhead relative to the chuck during inkjet printing onto a substrate that is held by the chuck. In some cases, at least one actuator can be provided that is configured to move the chuck and the gas knife relative to the inkjet printhead during printing.

In yet other embodiments of the present teachings, a method is provided for obtaining a substantially uniform distribution of a film-forming organic material in pixel banks formed on a substrate. The method can comprise holding a substrate with a chuck, wherein the substrate comprises a plurality of pixel banks formed on a print surface of the substrate. To facilitate the even distribution of inkjet ink in each pixel bank and form a uniform layer of ink in the pixel bank without ink pile-up, a sheet flow of gas can be directed from an outlet slot of a gas knife toward the print surface of the substrate. The gas knife can comprise an outlet slot having a length. The method can involve printing a first inkjet ink from a first inkjet printhead onto a first plurality of the pixel banks formed on the substrate. Then, more of the inkjet ink, or a different (second) inkjet ink can be printed from the same or from a different inkjet printhead onto a second plurality of the pixel banks formed on the substrate. In some cases, the first inkjet printhead and the second inkjet printhead can be the same inkjet printhead. In other cases, different inkjet printheads and/or different inks are used. The sheet flow of gas directed at the print surface can facilitate an even distribution of the inkjet ink within each pixel bank and can prevent a phenomenon called “pile-up” of ink within each pixel bank.

In some embodiments, the method can involve directing the sheet flow of gas toward the substrate during printing both of the first plurality and the second plurality of pixel banks. The sheet flow of gas can be directed from the gas knife at any suitable pressure, for example, at a pressure of from about 1.0 psig to about 25 psig, or from 2.0 psig to about 15 psig. The print surface of the substrate can comprise at least two rows of pixel banks wherein each row has a length. Each pixel bank can have a length and a width that is shorter than the length. The length of each pixel bank can be arranged or oriented substantially perpendicular to the length of the respective row of which it is a part.

In some cases, the outlet slot of the gas knife has a length that is substantially parallel to the length of each pixel bank and substantially perpendicular to the length of each row. In other cases, the outlet slot of the gas knife has a length that is substantially perpendicular to the length of each pixel bank and substantially parallel to the length of each row. For different inks, with different viscosities and other properties, different orientations can be preferred. The present methods can also comprise applying a vacuum through an evacuation port to suck up the sheet flow of gas after the sheet flow of gas is directed toward the substrate.

In yet other embodiments of the present teachings, a substrate printing system is provided that comprises a chuck, an inkjet printhead, and a gas movement device positioned in a fixed relationship relative to and adjacent to the inkjet printhead. The chuck can comprise a top surface configured to hold a substrate thereon. The inkjet printhead can be configured for printing an inkjet ink onto a print surface of a substrate while the substrate is held by the chuck. A supply of inkjet ink can be provided in fluid communication with the inkjet printhead, and the inkjet ink can comprise a carrier fluid or liquid and film-forming organic material dissolved or suspended in the carrier fluid. The gas movement device can be configured to direct a flow of gas onto the print surface of the substrate while the inkjet printhead prints the inkjet ink onto the print surface. The gas movement device can comprise a fan, two or more fans, or a gas knife. The gas movement device can be in fluid communication with a source of inert gas, such as nitrogen gas.

In some embodiments, the substrate printing system can further comprise an evacuation port and a vacuum source in fluid communication with the evacuation port. The evacuation port can be positioned relative to the gas movement device such that a flow of gas produced by the gas movement device is sucked away from the print surface through the evacuation port. In some cases, an enclosure can be provided to contain the chuck, the inkjet printhead, and the gas movement device, and the enclosure can contain an inert atmosphere such as an atmosphere of nitrogen gas. At least one heater can be provided that is configured to heat the chuck or to heat a substrate held by the chuck. In an exemplary embodiment, the gas movement device comprises at least two fans and the flow of gas is directed at a velocity of from about 0.5 m/s to about 5.0 m/s.

In yet another embodiment of the present teachings, an apparatus for drying a film-forming material in a carrier liquid is provided. The apparatus can be useful for thermal printing and can comprise, for example, a transfer member for receiving the film-forming material in the carrier liquid, and then for depositing dried film-forming material onto a substrate. The apparatus can comprise a vaporization region defined at least in part by a surface portion of the transfer member. The surface portion can be disposed along a first plane and the vaporization region can be configured to support a portion of the film-forming material in the carrier liquid. A heater can be arranged to heat the vaporization region. An evacuation port can be provided adjacent the vaporization region and can be oriented such that it intersects a line extending away from the vaporization region, substantially normal to the first plane. Further, a vacuum source can be provided that is in fluid communication with the evacuation port. In operation, the vacuum source can induce a gas flow extending from the vaporization region through the evacuation port and of sufficient flow to entrain and remove vapor located at or proximate the vaporization region.

According to various embodiments, instead of a single evacuation port, the apparatus can comprise an array of evacuation ports adjacent the vaporization region and intersecting a line extending away from the vaporization region and substantially normal to the first plane. In such cases, the vacuum source can be configured for fluid communication with the array of evacuation ports. In operation, the vacuum source can induce a gas flow extending from the vaporization region through the array of evacuation ports and of sufficient flow to entrain and remove vapor located at or proximate the vaporization region.

In yet other embodiments, the apparatus can comprise a purge gas port adjacent the vaporization region and located in the first plane on a side of the vaporization region opposite the evacuation port. A purge gas source can be provided that is configured to be in fluid communication with the purge gas port. In operation, the purge gas source and the vacuum source can induce a gas flow along a flow path extending through the vicinity of, and substantially parallel to, the vaporization region and through the evacuation port. The gas flow can be of sufficient volume and flow rate to entrain and remove vapor located at or proximate the vaporization region.

### BRIEF DESCRIPTION OF THE DRAWINGS

A better understanding of the features and advantages of the present teachings will be obtained by reference to the accompanying drawings, which are intended to illustrate, not limit, the present teachings. In the following illustrations, like elements are numbered similarly.

FIG. 1A is a plan view of a substrate that can be printed in accordance with various embodiments of the present teachings.

FIG. 1B is a plan view of a substrate as shown in FIG. 1A that has been printed with one or more inks.

FIG. 1C is a plan view of a substrate as shown in FIG. 1A that has been printed with one or more inks.

FIG. 2A is a cross-sectional view of a substrate that has been partially printed upon in accordance with various embodiments of the present teachings.

FIG. 2B is a cross-sectional view of the substrate shown in FIG. 2A that has been printed by first and second printer passes.

FIG. 2C is a cross-sectional view of the substrate shown in FIG. 2A that has been printed and partially dried.

FIG. 3A is a plan view of a substrate that has been printed with one or more inks using as least two passes of an inkjet printhead.

FIG. 3B is a plan view of a substrate that has been printed with one or more inks using as least two passes of an inkjet printhead in accordance with various embodiments of the present teachings.

FIG. 4 is a schematic diagram demonstrating the Marangoni effect.

FIG. 5A is a plan view of a substrate containing a plurality of pixels and a gas knife directing a sheet flow stream of air across the substrate in a direction in-line with the lengths of the plurality of pixels.

FIG. 5B is a plan view of a substrate containing a plurality of pixels and a gas knife directing a sheet flow stream of gas across the substrate wherein the substrate is configured such that the stream of gas is perpendicular to the lengths of the plurality of pixels.

FIG. 6A is a top, right perspective view of an inkjet printing system, in accordance with various embodiments of the present teachings, configured such that a substrate containing a plurality of pixels rests on a chuck and a gas knife is able to produce a sheet flow stream of gas across the substrate in a direction in-line with the lengths of the plurality of pixels.

FIG. 6B is an enlarged, top, right perspective view of an alternative to the inkjet printing system shown in FIG. 6A.

FIG. 6C is a top, right perspective view of an alternative to the inkjet printing system shown in FIG. 6A.

FIG. 6D is a plan view of the inkjet printing system shown in FIG. 6A.

FIG. 7A is a top, right perspective view of an inkjet printing system, in accordance with various embodiments of the present teachings, wherein a substrate containing a plurality of pixels and a gas knife are configured such that the gas knife directs a sheet flow stream of gas across the substrate, which is perpendicular to the lengths of the plurality of pixels.

FIG. 7B is a top, right perspective view of an alternative to the inkjet printing system shown in FIG. 7A.

FIG. 7C is a plan view of the inkjet printing system shown in FIG. 7A.

FIG. 7D is a top, left perspective view of the inkjet printing system shown in FIG. 7A.

FIG. 8 schematically illustrates a solvent vapor removal apparatus in accordance with various embodiments of the present teachings.

FIG. 9 schematically illustrates a solvent vapor removal apparatus that can be in a temporary relationship with a transfer surface in accordance with various embodiments of the present teachings.

FIG. 10 illustrates the same apparatus as FIG. 9 but at a different point in time.

FIG. 11 schematically illustrates a solvent vapor removal apparatus that can be in a temporary relationship with a transfer surface in accordance with various embodiments of the present teachings.

FIG. 12 illustrates the same apparatus as FIG. 11 at a different point in time.

FIG. 13 schematically illustrates a solvent vapor removal apparatus that can be in a temporary relationship with a transfer surface in accordance with yet other embodiments of the present teachings.

FIG. 14 schematically illustrates a solvent vapor removal apparatus that comprises multiple units of the solvent vapor removal apparatus of FIG. 9, in accordance with various embodiments of the present teachings.

FIG. 15 schematically illustrates a solvent vapor removal apparatus that comprises a larger unit of the solvent vapor removal apparatus of FIG. 8 according to yet other embodiments of the present teachings.

FIG. 16 schematically illustrates a solvent vapor removal apparatus as a part of a rotating drum deposition system according to another embodiment of the present teachings.

FIG. 17 schematically illustrates a solvent vapor removal apparatus as a part of a rotating faceted drum deposition system according to another embodiment of the present teachings.

FIG. 18 schematically illustrates a solvent vapor removal apparatus that is part of a film-forming apparatus according to yet another embodiment of the present teachings.

FIG. 19 schematically illustrates a solvent vapor removal apparatus that is part of a film-forming apparatus according to yet another embodiment of the present teachings.

FIG. 20 schematically illustrates a solvent vapor removal apparatus that comprises multiple units of the solvent vapor removal apparatus of FIG. 18 according to yet another embodiment of the present teachings.

FIG. 21 is a flow diagram illustrating a method for forming a film according to various embodiments of the present teachings.

FIG. 22 is a flow diagram illustrating a method for forming a film according to various embodiments of the present teachings.

FIG. 23 is a schematic diagram showing different gas speeds at various positions on a substrate, in accordance with various embodiments of the present teachings.

FIG. 24 is a schematic representation of a substrate that has been printed at various locations where drying times are different, in accordance with various embodiments of the present teachings.

FIG. 25 is a schematic representation of a substrate printed with one or more inks and indicating t various locations of the substrate where drying times are different, in accordance with various embodiments of the present teachings.

### DETAILED DESCRIPTION OF THE DISCLOSURE

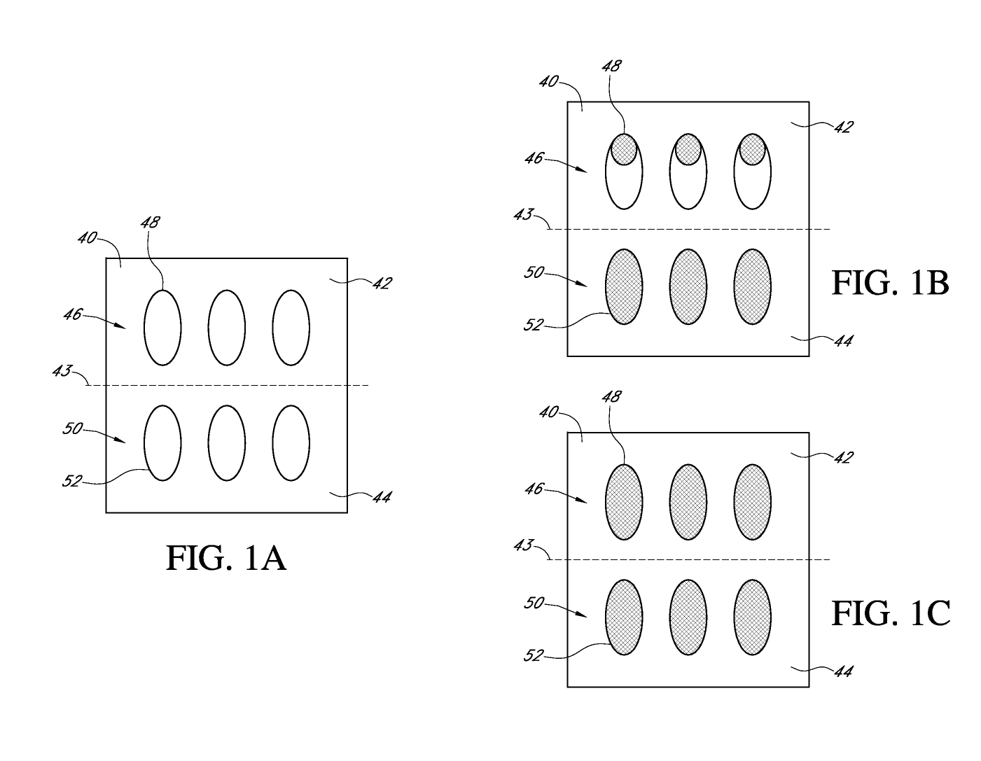

The present teachings relate to the discovery of and solution to a vexing problem facing printing of various inks on substrates. The problem involves a phenomenon that is termed here as “pile-up.” Pile-up can occur when a first region of pixels is printed on a substrate and then a second adjacent region is printed on the same substrate. At the interface between these two regions, a row of pixels in the first printing region can experience pile-up, that is, ink dries in such a way that more ink ends up at one end of the pixel bank than at an opposite end of the pixel bank. As a result, a non-uniform pixel is created. This phenomenon can be better appreciated with reference to FIGS. 1A, 1B, and 1C.

FIG. 1A is a plan view of a schematic representation of a substrate 40. Substrate 40 is shown divided into two regions, a first region 42, and a second region 44, the interface of the two being a boundary 43. A pixel bank 48 is shown in a first row of pixel banks 46 in first region 42. A second pixel bank 52 is shown in a second row of pixel banks 50 in second region 44. FIG. 1B shows the after-effects of printing in first region 42 and first region 44. An ink, shown in black, is evenly distributed in the pixel banks of row 52 in second region 44. The ink is shown concentrated on one end of pixel banks in row 46 of region 42. The pixel banks of row 46 have experienced the phenomenon of pile-up. FIG. 1C shows a printed substrate of substrate of substrate 40 that can be achieved in accordance with the present teachings, which results in even distribution of ink in the pixel banks of both first row 46 and second row 50.

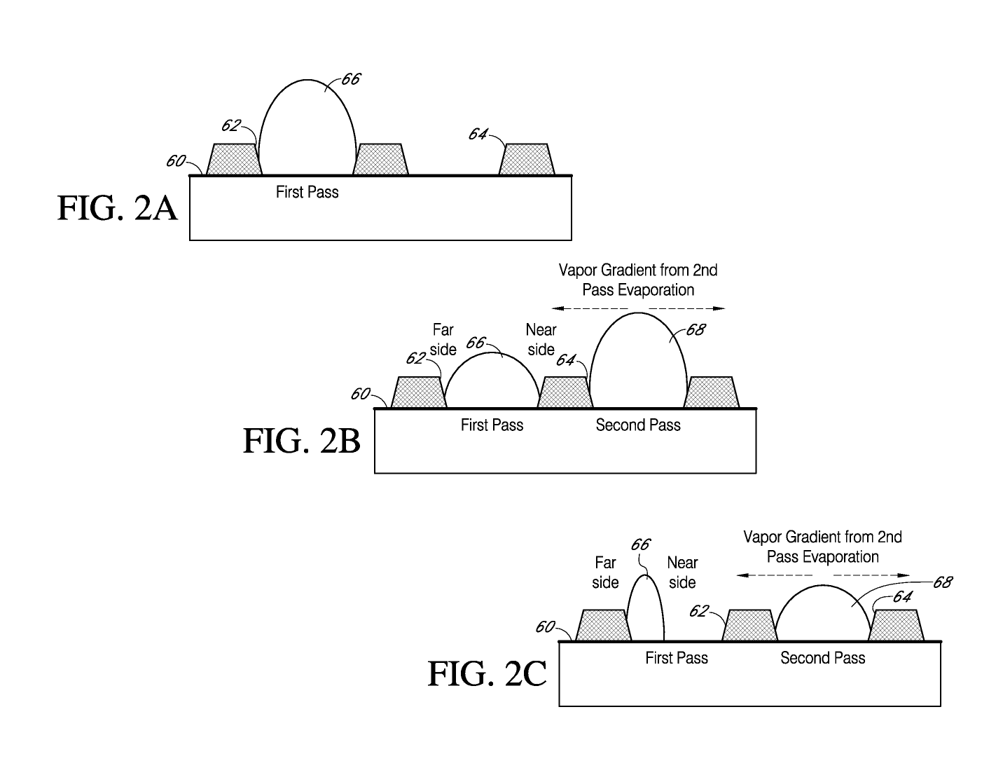

FIGS. 2A, 2B, and 2C are cross-sectional views of a substrate 60 containing a first pixel bank 62 and a second pixel bank 64. FIG. 2A shows substrate 60 after a first pass of an inkjet printhead has occurred and deposited an ink droplet 66 into pixel bank 62. FIG. 2B shows substrate 60 after both a first pass and a second pass of an inkjet printhead has occurred. The second pass of the inkjet printhead has deposited a second ink drop 68 into pixel bank 64. At this snapshot in time, the first ink drop at 66 has been drying in a uniform manner. FIG. 2C shows a cross-sectional view of substrate 60 at a short time point subsequent to that shown in FIG. 2B. At this point in time, while second ink drop 68 has dried substantially uniformly, the effect of pile-up has caused first ink drop at 66 to dry in a non-uniform manner. First ink drop at 66 has massed on a far side of pixel bank 62 and drawn away from the near side of first pixel bank 62.

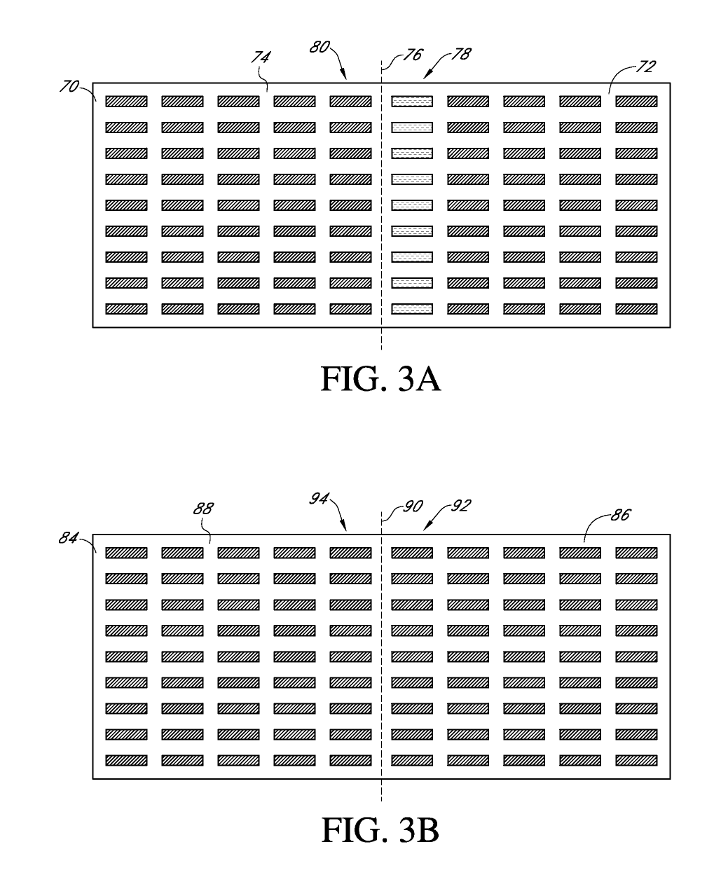

FIG. 3A is a plan view of a substrate 70 that is divided into a first region 72 and a second region 74. Both of these regions comprise a plurality of pixels arranged in rows and columns. First region 72 has been printed with one or more inks from a first pass of an inkjet printhead, and on the other side of boundary 76, pixels have been inked with one or more inks during a second pass of an inkjet printhead in second region 74. Column 78 is shown adjacent to boundary 76 in first region 72. The pixels in first row 78 have experienced the phenomenon of pile-up and display a lighter intensity than other pixels in region 72 and second region 74. In contrast, row 80 of pixels in region 74 and adjacent to boundary 76, has been uniformly deposited with ink and dried uniformly as well.

FIG. 3B shows a plan view of a substrate 84 that has been printed with one or more inks in accordance with the present teachings and does not demonstrate the phenomenon of pile-up. Substrate 84, analogous to substrate 70 in FIG. 3A, is divided into a first region 86, and a second region 88, divided by a boundary 90. First region 86 has been printed with a first pass of an inkjet printhead and second region 88 has been printed with a second pass of an inkjet printhead. First row of pixels 92 in first region 86 adjacent to boundary 90 does not show the phenomenon of pile-up in contrast to first row 78 in FIG. 3A. Second pixel row 94, adjacent to boundary 90, is shown with a uniform distribution of ink in the pixels which is comparable to that of the pixels in second row 92. FIG. 3B shows the surprising and unexpected results that can be achieved in accordance with the various teachings described herein.

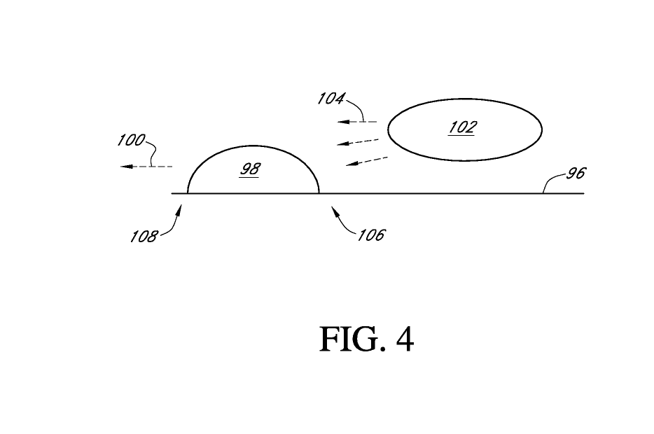

FIG. 4 is a schematic diagram of the Marangoni effect. On a substrate 96, a droplet of water 98 is shown that is moving in a direction 100 as indicated by the dashed arrow. An isopropanol vapor source 102 is shown adjacent to water droplet 98. Dashed arrows 104 show the vapor direction impacting on water droplet 98. Because of a relatively high concentration of isopropanol vapor at position 106, relative to a relatively low concentration of isopropanol vapor at position 108, water droplet 98 moves in the direction indicated by dashed arrow 100 as a result of the Marangoni effect. For example, isopropanol vapor (surface tension of about 22 dyne/cm) can be used to “push” water (surface tension of about 72 dyne/cm) droplets off a glass surface. The Marangoni effect may be responsible for the pile-up effect addressed by the present teachings. The present teachings, however, are not dependent on or limited by any particular theory as to the cause of the pile-up phenomenon.

A gradient in surface tension in a fluid applies a force on the fluid in the direction of the higher surface tension. This surface tension gradient is typically due to a gradient in fluid composition. This effect is observed in the observed drop drying phenomena: there are gradients in the composition in the ink drops due to the combination of the different drying rates of the different components and the different drying rates of the different regions of the drop (faster drying at edges versus center). Such gradients can also occur due to an ambient vapor gradient via two phenomena: absorption of the vapor into the fluid and/or suppressed drying of the drop (in both cases proportional to the spatially varying concentration).

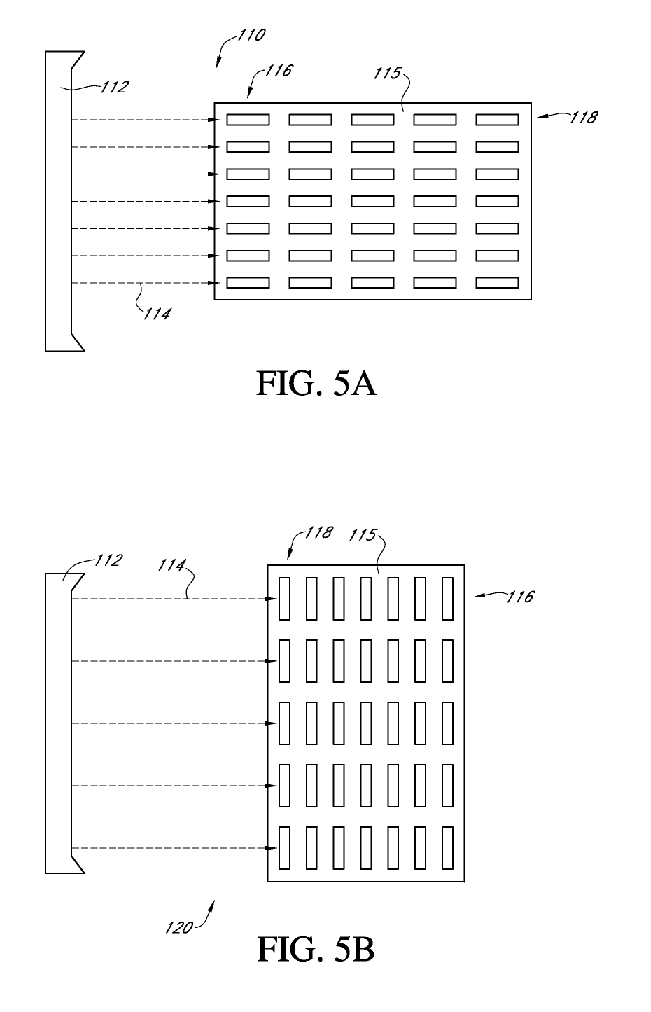

FIG. 5A is a plan view of a schematic representation of a portion of an inkjet printing system and method in accordance with various embodiments of the present teachings. In inkjet printing system 110, a gas knife 112 emits a stream of gas 114 in the form of a sheet flow across a substrate 116 such that the direction of the stream of gas 114, represented by the broken arrows, is in-line with the lengths of the various pixels. That is, the gas flow 114 moves across the pixels in row 116 and column 118 on the surface of substrate 115 in an orientation termed “in-pixel.” FIG. 5B is a schematic diagram of an alternative configuration of an inkjet printing system 120 showing gas knife 112 emitting a stream of gas 114 in the form of a sheet flow. In this configuration, the stream of gas moves perpendicularly to column 118 and across row 116, as well as perpendicularly to the lengths of the pixels in row 116, in an orientation termed “cross-pixel.”

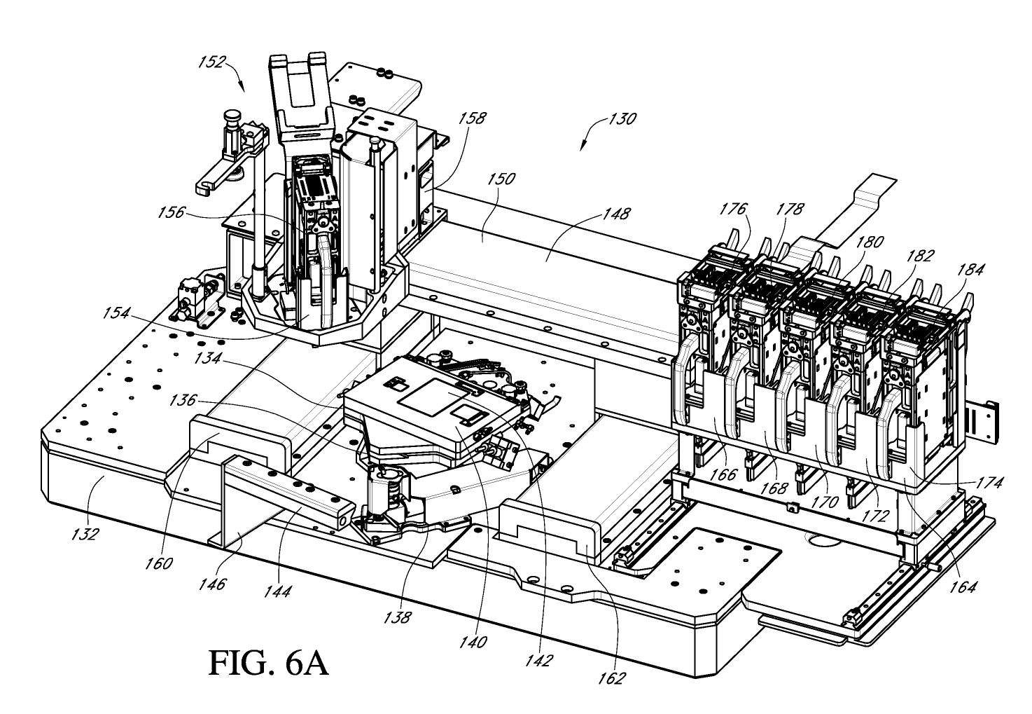

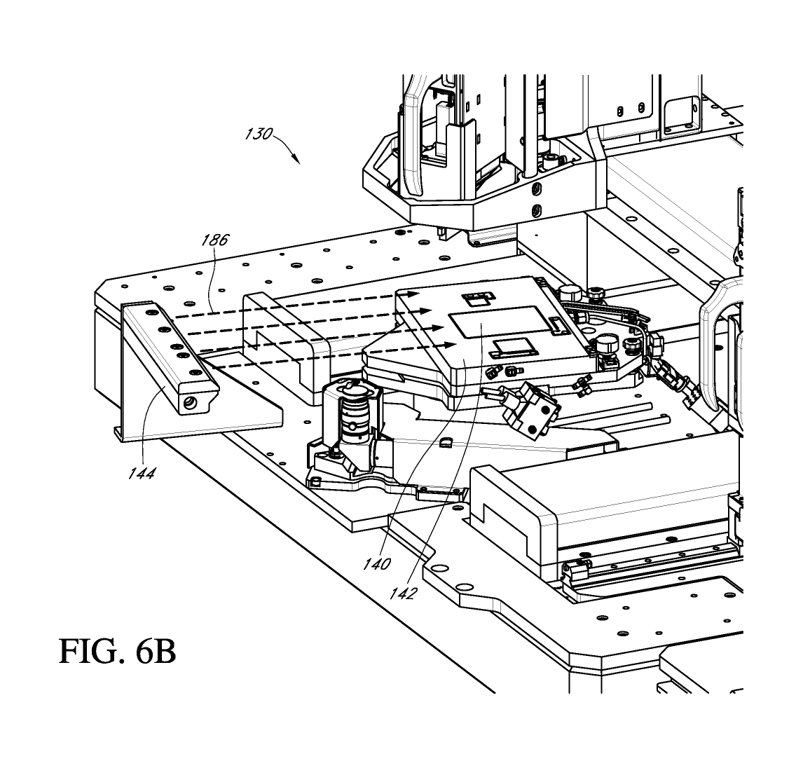

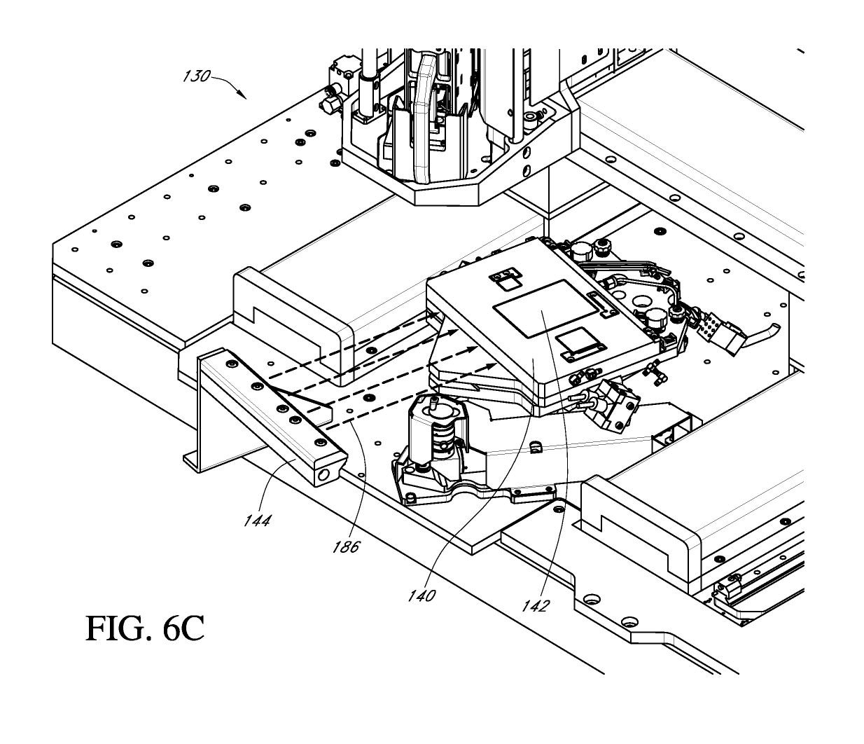

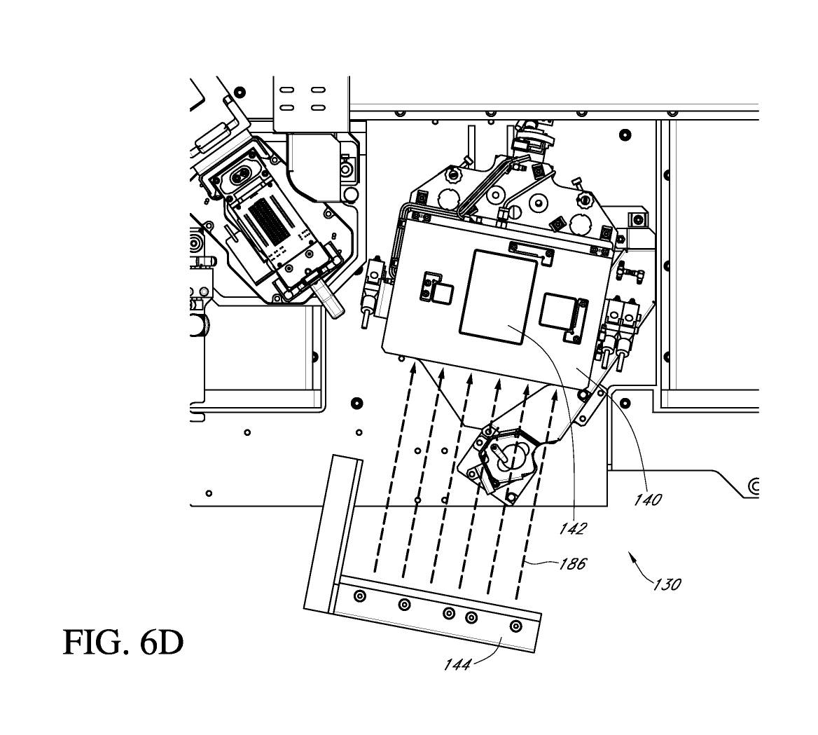

FIG. 6A is a top, right perspective view of an inkjet printing system 130 in accordance with various embodiments of the present teachings. Various components of system 130 are attached to a base 132. A chuck 134 is attached to base 132 through a chuck mount 136. Chuck 134 comprises a top chuck layer 136 that has a top chuck surface 140. Top chuck surface 140 can support a substrate 142. A gas knife 144 is connected to base 132 through a gas knife support 146. Gas knife 144 is oriented to flow a stream of gas across substrate 142 in an in-pixel configuration. A gantry 148 comprises a rail beam 150 that allows movement of inkjet printhead assembly 152 to move in an x-axis direction. Inkjet printhead assembly 152 comprises a first ink cartridge slot 154 that contains a first ink cartridge 156. A vertical actuator 158 is operatively associated with and allows movement in the z-axis direction of inkjet printhead assembly 152. First y-axis actuator 160 and second y-axis actuator 162 allow movement of gantry 148 in the y-axis direction. Opposite inkjet printhead assembly 152 along gantry 148 is an inkjet cartridge supply rack 164. Inkjet supply rack 164 comprises a second inkjet cartridge slot 166, a third ink cartridge slot 168, a fourth ink cartridge slot 170, a fifth ink cartridge slot 172, and a sixth ink cartridge slot 174. A second ink cartridge 176 is held by second ink cartridge slot 166, a third ink cartridge 178 is held by third ink cartridge slot 168, a fourth ink cartridge 180 is held by fourth ink cartridge slot 170, a fifth ink cartridge 182 is held by fifth ink cartridge slot 172, and a sixth ink cartridge 184 is held by sixth ink cartridge slot 174.

FIG. 6B is an alternative top, right perspective view of inkjet printing system 130 shown in FIG. 6A. Chuck top surface 140 supports substrate 142 relative to gas knife 144, which emits a stream of gas indicated with dashed arrows 186 in an in-pixel configuration. FIG. 6C is still another alternative top, right perspective view of the inkjet printing system 130 shown in FIG. 6A. Substrate 142 rests on chuck top surface 140 and is positioned relative to gas knife 144. A stream of gas indicated by dashed arrows 186 is emitted by air knife 144 across substrate 142 and in an in-pixel configuration. FIG. 6D is a plan view of the inkjet printing system 130 shown in FIG. 6A. Substrate 142 is again supported by top chuck surface 140. Gas knife 144 emits a stream of gas indicated by dashed arrows 186 in an in-pixel configuration relative to substrate 142.

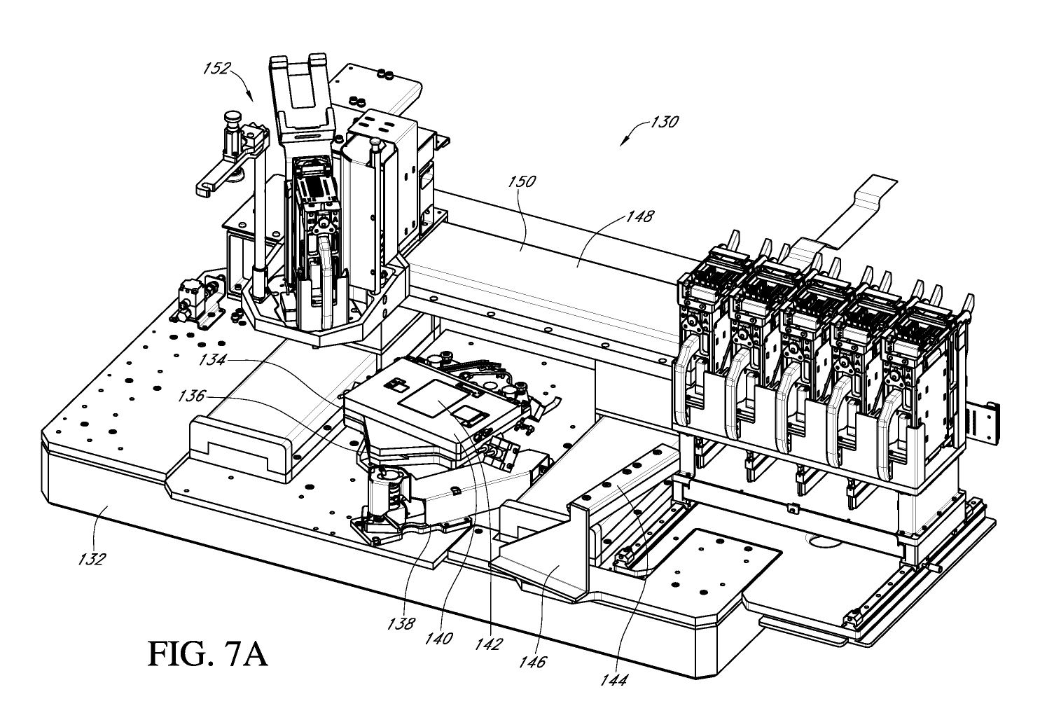

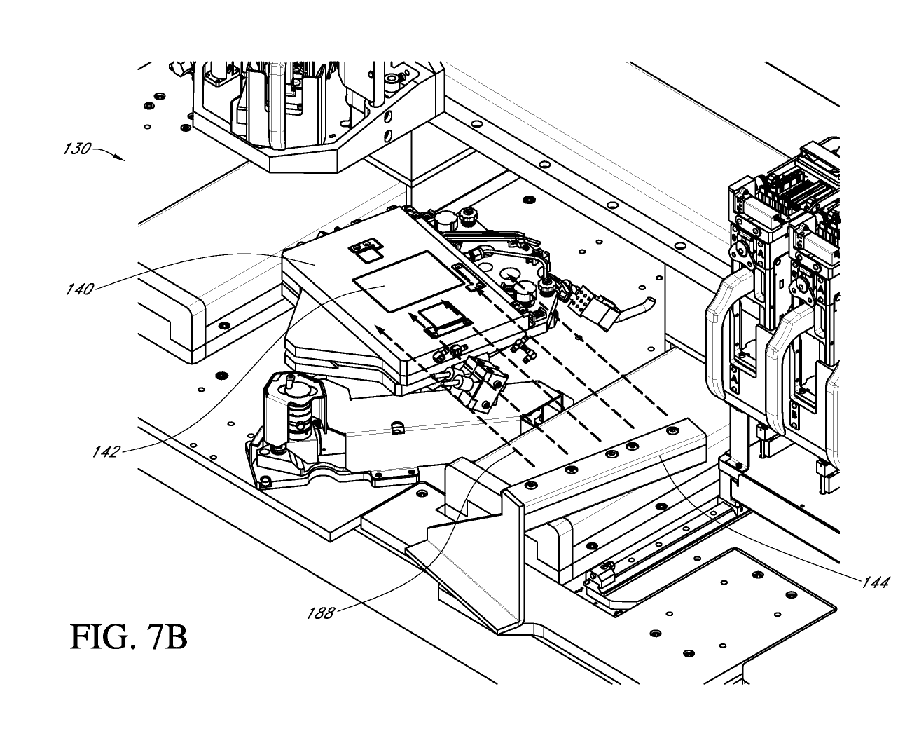

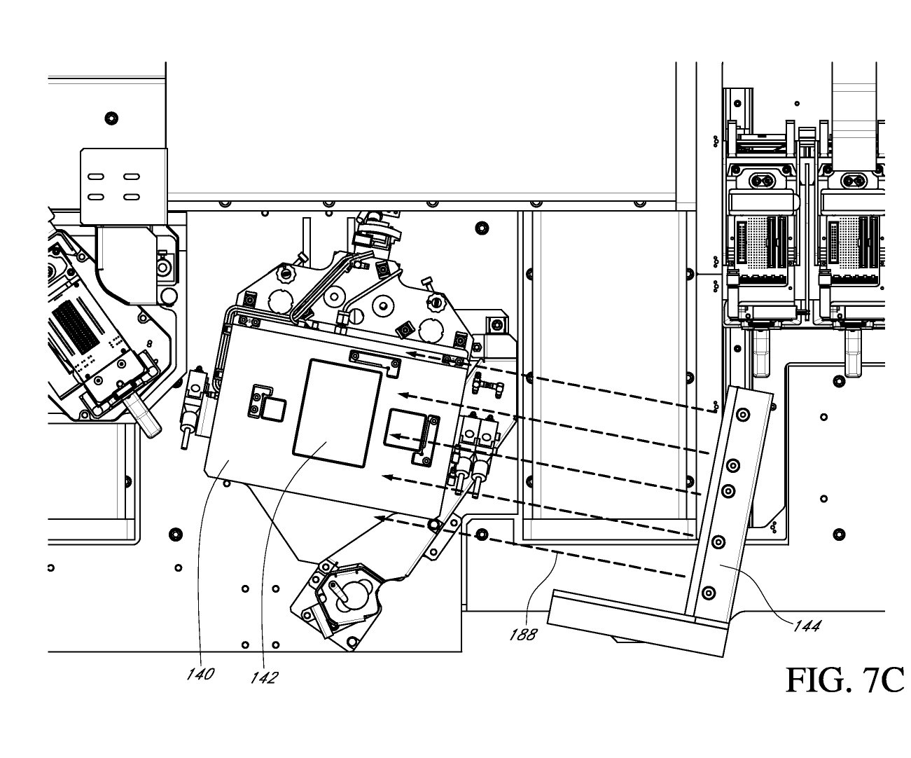

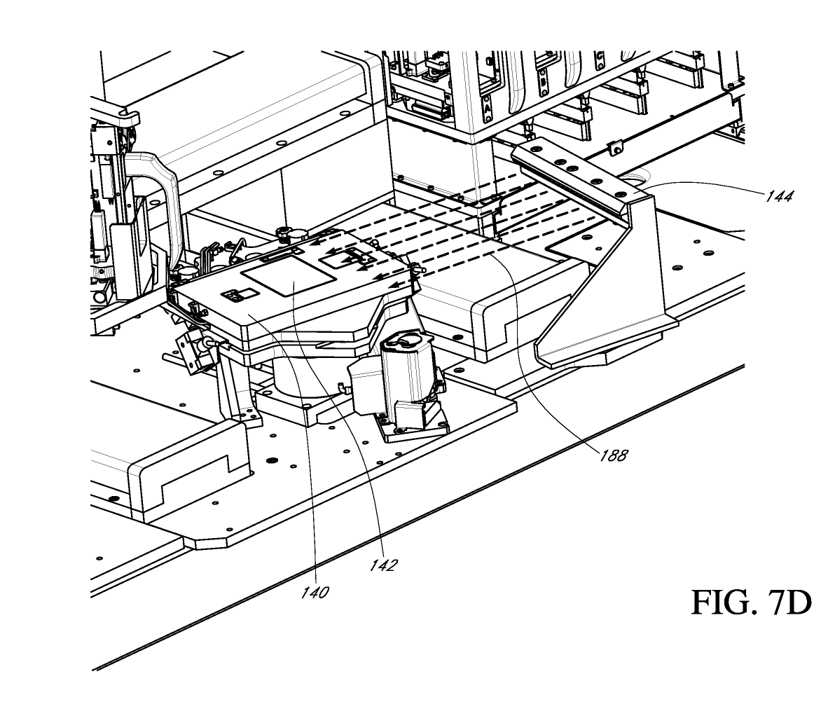

FIG. 7A is a top, right perspective view of inkjet printing system 130 showing g a cross-pixel configuration. Chuck 134 is attached to base 132 through chuck support 136. Top chuck layer 138 has a top chuck surface 140 supporting substrate 142. Gas knife 144 is connected to base 132 through gas knife support 146. Gas knife 144 is configured relative to substrate 142 to blow a gas stream across substrate 142 in a cross-pixel configuration. Gantry 148 comprises track beam 150, allowing movement of inkjet printhead assembly 152. FIG. 7B is an alternative top, right perspective view of inkjet printing system 130 shown in FIG. 7A. Chuck top surface 140 supports substrate 142 relative to gas knife 144. A stream of gas 188 is emitted by gas knife 144 and moves across substrate 142 in a cross-pixel configuration. FIG. 7C is a plan view of the inkjet printing system 130 shown in FIG. 7A. Chuck top surface 140 supports substrate 142 relative to gas knife 144. A stream of gas 188 emits from gas knife 144 across substrate 142 in a cross-pixel configuration. FIG. 7D is a top, left perspective view of the inkjet printing system 130 shown in FIG. 7A. Chuck top surface 140 supports substrate 142. Gas knife 144 is oriented such that gas stream 188 is emitted by gas knife 144 and blows across substrate 142 in a cross-pixel configuration.

According to various embodiments of the present teachings, a substrate printing system comprising a chuck, an inkjet, and a printhead is provided. The chuck can comprise a top surface configured to hold a substrate. The inkjet printhead can be configured for inkjet printing onto the substrate. The gas knife can comprise an inlet for receiving pressurized gas from a pressurized gas source, and an outlet slot having a length and being configured to direct pressurized gas from the gas knife in a sheet flow toward a substrate held by the chuck.

The inkjet printhead can be in fluid communication with a supply of ink and the ink comprises a carrier fluid and film-forming organic material dissolved or suspended in the carrier fluid. Any suitable ink can be used. Examples of inks include those for constructing an emissive layer, a hole transport layer, a hole injection layer, any other layer of an organic light-emitting device, and the like.

Any suitable chuck can be used as port of the substrate printing system. For example, a multi-substrate or universal chuck can be used that is capable of holding different size substrates. The chuck can include multiple layers, one or more of which can provide specific positioning control. The substrate printing system can further comprise a substrate held by the chuck. Any suitable type of substrate can be used. For example, a glass substrate can be used and/or a substrate comprising indium tin oxide (ITO). The substrate can be pre-layered before being treated by the substrate printing system so as to provide various integrated electronic components and pixels banks configured for accepting and fencing-in ink. The substrate can include any number of pixels, pixel banks, pixel rows, rows of pixel banks, pixel columns, and rows of pixel columns. In some embodiments, the substrate comprises at least two rows of pixel banks with each pixel bank being configured to fence-in organic material for forming a pixel, each row having a length, each pixel bank having a length, and each pixel bank having a width that is shorter than its length. The lengths of the pixel banks in each row can be arranged substantially perpendicular to the length of the respective row, and the length of the outlet slot of the gas knife can be oriented substantially parallel to the length of each pixel bank and substantially perpendicular to the length of each row.

In some embodiments, the substrate comprises at least two rows of pixel banks with each pixel bank being configured to fence-in organic material for forming a pixel. Each row has a length and each pixel bank has a length and a width that is shorter than the length. The lengths of the pixel banks in each row can be arranged substantially perpendicular to the length of the respective row, and the length of the outlet slot of the gas knife can be oriented substantially perpendicular to the length of each pixel bank and substantially parallel to the length of each row.

Any suitable vacuum source and accompanying vacuum apparatus can be used as part of and/or in conjunction with the substrate printing system. In some embodiments, the substrate printing system comprises an evacuation port and a vacuum source in fluid communication with the evacuation port, wherein the evacuation port is positioned relative to the gas knife such that a sheet flow of gas produced by the gas knife is sucked away through the evacuation port. The evacuation port can be mounted adjacent to the inkjet printhead and the evacuation port and the inkjet printhead are configured to move in tandem relative to the top surface of the chuck. The evacuation port can be located in other positions in the alternative or in addition to such placement. Any suitable number of evacuation ports can be used. A vacuum of any suitable strength can be used. For example, the vacuum can be pulled through the evacuation port at a negative pressure of from about −3.0 psig to about −13 psig, from about −5.0 psig to about −10 psig, or about −7.5 psig.

The position of the air knife relative to the substrate on the chuck can be varied such that a suitable supply, flow, pressure, and speed of gas is applied to and/or across the surface of the substrate. In some embodiments, the substrate is positioned on the top surface of the chuck. The substrate comprises a top surface, a lateral edge, a length, and a width, wherein the gas knife is spaced from the lateral edge by a first distance. The first distance can be larger than the length of the substrate, for example, at least twice the length of the substrate. The length of the substrate can be oriented substantially perpendicular to the length of the outlet slot. In some embodiments, the first distance is greater than half the width of the substrate, or about equal to the width of the substrate, or greater than the width of the substrate, or at least twice the width of the substrate. The width of the substrate can be substantially perpendicular, substantially parallel, or in some other angled orientation, relative to the length of the outlet slot.

The substrate printing system can be enclosed by an enclosure that contains the chuck, the inkjet printhead, and the gas knife. The enclosure can contain an atmosphere comprising one or more gasses that are the same or different than the gas or gasses emitted from the gas knife. In some embodiments, the gas or gasses comprise an inert gas. In some embodiments, the reactive gas content of the gas or gasses is less than 1.0 vol. % of the total volume of the gas stream or gas atmosphere. Examples of suitable inert gasses include nitrogen, noble gasses such as argon, or any combination thereof.

The substrate printing system can comprise one or more actuator for moving one or more component such as the inkjet printhead assembly, the chuck, and the substrate. In some embodiments, a printhead actuator is provided that is configured to move the inkjet printhead relative to the chuck during printing onto a substrate held by the chuck. In some embodiments, at least one actuator is provided and configured to move the chuck and the gas knife relative to the inkjet printhead during printing.

In accordance with various embodiments of the present teachings, a method for obtaining a substantially uniform distribution of a film-forming organic material in pixel banks is provided, for example, in pixel banks formed on a substrate. The method can include one or more of the following steps or features. A substrate can be held by a chuck. The substrate can comprise a plurality of pixel banks formed on a print surface thereof. A sheet flow of gas from an outlet slot of a gas knife can be directed toward the substrate held by the chuck. The outlet slot can have a height and a length, and the length can be many times the dimension of the height.

An inkjet ink can be printed from a first inkjet printhead onto a first plurality of the pixel banks formed on the print surface. Inkjet ink from the same printhead or from a second inkjet printhead can be printed onto a second plurality of the pixel banks formed on the substrate. The first and second inks can be the same or different. The method can be performed so that the sheet flow of gas facilitates an even distribution of the inkjet ink within each pixel bank and prevents pile-up of inkjet ink within each pixel bank. In some embodiments, the first inkjet printhead and the second inkjet printhead are the same inkjet printhead.

The method can employ any suitable inkjet printing system or component thereof. For example, the method can employ the inkjet printer tool or any component thereof as described in U.S. Patent Application No. 61/625,659, filed Apr. 17, 2012, which is incorporated herein in its entirety by reference.

The flow of gas can be varied in shape, pressure, velocity, temperature, and direction. Any suitable gas knife, such as a conventional air knife, can be used to provide the flow of gas. For example, air knives available from Exair Corporation (Cincinnati, Ohio), AirTX International (Cincinnati, Ohio), JetAir Technologies, LLC (Ventura, Calif.), STREAMTEK (Charlotte, N.C.), Sonic Air Systems (Brea, Calif.), or Nex Flow Air Products Corp. (Williamsville, N.Y.), can be used. In some embodiments, the sheet flow of gas is directed toward the substrate during the printing onto both of the first plurality and the second plurality of pixel banks. In some embodiments, the sheet flow of gas is directed from the gas knife at a pressure of from about 1.0 psig to about 25 psig., from about 2.0 psig to about 20 psig, from about 3.0 psig to about 12 psig, or from about 5 psig to about 10 psig. In some embodiments, a vacuum is applied through an evacuation port to suck up the sheet flow of gas after the sheet flow of gas is directed toward the substrate.

In some embodiments, the print surface of the substrate can comprise at least two rows of pixel banks, with each row having a length, with each pixel bank having a length and a width that is shorter than the length, and with the length of each pixel bank being arranged substantially perpendicular to the length of its respective row. In such cases, the outlet slot of the gas knife can have a length that is substantially parallel to the length of each pixel bank and substantially perpendicular to the length of each row.

In some embodiments, the print surface of the substrate can comprise at least two rows of pixel banks, with each row having a length, with each pixel bank having a length and a width that is shorter than the length, and with the length of each pixel bank being arranged substantially perpendicular to the length of its respective row. In such cases, the outlet slot of the gas knife can have a length that is substantially perpendicular to the length of each pixel bank and substantially parallel to the length of each row.

In accordance with various embodiments of the present teachings, a substrate printing system is provided comprising a chuck, an inkjet printhead, a supply of inkjet ink, and a gas movement device. The gas movement device can differ from the gas knife described herein and can comprise, for example, a fan, two or more fans, a nozzle, an air pump, or the like. The chuck can comprise a top surface and be configured to hold a substrate on the top surface. The chuck can be a vacuum chuck or can comprise clamps, alignment pins, or other securing features or fasteners. The inkjet printhead can be configured for printing an inkjet ink onto a print surface of a substrate while the substrate is held by the chuck. The supply of inkjet ink can be in fluid communication with the inkjet printhead, and the inkjet ink can comprise a carrier fluid and film-forming organic material dissolved or suspended in the carrier fluid. The gas movement device can be positioned in a fixed relationship relative to and adjacent to the inkjet printhead. The gas movement device can be configured to direct a flow of gas onto the print surface of the substrate while the inkjet printhead prints the inkjet ink onto the print surface. In some embodiments, the gas movement device is in fluid communication with a source of inert gas, such as nitrogen gas.

The substrate printing system can comprise an evacuation port and a vacuum source in fluid communication with the evacuation port, wherein the evacuation port is positioned relative to the gas movement device such that a flow of gas produced by the gas movement device is sucked away from the print surface through the evacuation port. The substrate printing system can be enclosed in an enclosure that contains the chuck, the inkjet printhead, and the gas movement device. The enclosure can contain an inert gas atmosphere, for example that comprises nitrogen gas. The substrate printing system can comprise at least one heater configured to heat a substrate held by the chuck. In some embodiments, the gas movement device comprises at least two fans that generate a flow of gas. The flow of gas can be supplied at any suitable shape, flow rate, pressure, or velocity. In an exemplary embodiment, the gas flow can be directed from the gas movement device at a velocity of from about 0.1 m/s to about 10 m/s, from about 0.5 m/s to about 5.0 m/s, from about 1.0 m/s to about 3.5 m/s, or from about 1.5 m/s to about 2.5 m/s.

Methods and apparatuses are also provided for removing carrier liquid vaporized from the ink and thus for preventing the recondensation of carrier liquid. More specifically, the method and apparatus can be used for depositing a solid ink, for example, an organic light-emitting device material, onto a substrate while removing vaporized carrier liquid in which the organic material had been dispersed or dissolved. The apparatus can comprise a transfer member, a vaporization region, a heater, an evacuation port, and a vacuum port. The transfer member can be configured for receiving the organic material in the carrier liquid, drying the organic material, and depositing the dried organic material onto a substrate. The organic material can be an organic film-forming material useful in forming one or more layers of an organic light-emitting device. The vaporization region can be defined at least in part by a surface portion of the transfer member, wherein the surface portion is disposed along a first plane, and further wherein the vaporization region is configured to support a portion of the film-forming material in the carrier liquid. The heater can be adapted to heat the vaporization region. The evacuation port can be located adjacent the vaporization region and intersecting a line extending away from the vaporization region, substantially normal to the first plane. The vacuum source can be adapted for fluid communication with the evacuation port. In operation, the vacuum source can induce a gas flow extending from the vaporization region through the evacuation port and of sufficient volume and flow rate to entrain and remove vapor located at or proximate to the vaporization region.

According to various embodiments of the present teachings, an apparatus for drying a film-forming material in a carrier liquid is provided. The apparatus can comprise a transfer member, a vaporization region, a heater, an array of evacuation ports, and a vacuum source. The transfer member can be configured for receiving the film-forming material in the carrier liquid, and depositing dried film-forming material onto a substrate. The vaporization region can be defined at least in part by a surface portion of the transfer member, wherein the surface portion is disposed along a first plane, and further wherein the vaporization region is configured to support a portion of the film-forming material in the carrier liquid arranged in an array of drops. The heater can be adapted to heat the vaporization region. The array of evacuation ports can be provided adjacent the vaporization region and intersecting a line extending away from the vaporization region, and substantially normal to the first plane, wherein the array of evacuation ports corresponds in number, array size, and array shape, to the array of drops. The vacuum source can be adapted for fluid communication with the evacuation ports. In operation, the vacuum source can induce a gas flow extending from the vaporization region through the evacuation ports and of sufficient volume and flow rate to entrain and remove vapor located at or proximate to the vaporization region.

According to various embodiments of the present teachings, an apparatus for drying a film-forming material in a carrier liquid is provided. The apparatus can comprise a transfer member, a vaporization region, a heater, an evacuation port, a vacuum source, a purge gas port, and purge gas source. The transfer member can be configured for receiving the film-forming material in the carrier liquid, and depositing dried film-forming material onto a substrate. The vaporization region can be defined at least in part by a surface portion of the transfer member, wherein the surface portion is disposed along a first plane, and further wherein the vaporization region is configured to support a portion of the film-forming material in the carrier liquid. The heater can be adapted to heat the vaporization region. The evacuation port can be located adjacent the vaporization region and located in the first plane. The vacuum source can be adapted for fluid communication with the evacuation port. A purge gas port can be located adjacent the vaporization region and located in the first plane on a side of the vaporization region opposite the evacuation port. The purge gas source can be adapted for fluid communication with the purge gas port. In operation, the purge gas source and the vacuum source induce a gas flow along a flow path extending through the vicinity of, and substantially parallel to, the vaporization region and through the evacuation port. The gas flow can be of sufficient volume and flow rate to entrain and remove vapor located at or proximate to the vaporization region.

In some embodiments, the gas flow has a flow rate of from about 0.03 to about 1.5 standard liters per minute, or from about 0.1 to about 0.8 standard liters per minute. The evacuation port can have a diameter of from about 50 to about 300 micrometers, or from about 100 to about 200 micrometers. In some embodiments, the evacuation port can be separated from the vaporization region by a distance of from about 50 to about 200 micrometers, or from about 100 to about 200 micrometers. In some embodiments, there can be a solvent trap in fluid communication with the evacuation port and the vacuum source. The film-forming material can include an organic light-emitting device material, for example, for forming a layer of an OLED. In some embodiments, the evacuation port and the vaporization region are movable relative to one another.

The surface portion can include at least one surface feature. In some embodiments, the at least one surface feature comprises a first opening on a first face of the transfer member, and further wherein the transfer member includes a channel that extends from the first opening, through the transfer member to a second opening formed on a second, opposing face of the transfer member. The vaporization region can be configured to support a portion of the film-forming material in the carrier liquid as a multiplicity of drops arranged in an array and wherein the evacuation port is adapted to induce a gas flow over the entire array sufficient to entrain and remove vapor located at or proximate to the vaporization region. In some embodiments, the gas flow has a flow rate of from about 0.03 to about 1.5 standard liters per minute per drop of film-forming material, or from about 0.1 to about 0.8 standard liters per minute per drop of film-forming material.

In some embodiments, the vaporization region is configured to support a portion of the film-forming material in the carrier liquid as a multiplicity of drops arranged in an array. The gas flow can have a flow rate of from about 0.03 to about 1.5 standard liters per minute per drop of film-forming material, or from about 0.1 to about 0.8 standard liters per minute per drop of film-forming material. The purge gas port and the evacuation port can be sized such that the gas velocities in the ports are less than Mach 1. In some embodiments, the purge gas port and the evacuation port are separated from the vaporization region by from about 200 micrometers to about 2 millimeters. The purge gas port and/or the evacuation port can be elongated. A linear array of purge gas ports and/or a linear array of evacuation ports can be provided.

According to various embodiments of the present teachings, an apparatus for drying a film-forming material in a carrier liquid is provided. The apparatus can comprise a transfer member, a multiplicity of vaporization regions, a heater, an array of evacuation ports, a vacuum source, an array of purge gas ports, and a purge gas source. The transfer member can be configured for receiving the film-forming material in the carrier liquid, and depositing dried film-forming material onto a substrate. The multiplicity of vaporization regions can be arranged in an array, each vaporization region defined at least in part by a respective surface portion of the transfer member, wherein each respective surface portion is disposed along a first plane, and further wherein each vaporization region is configured to support a respective portion of the film-forming material in the carrier liquid. The heater can be adapted to heat the array of vaporization regions. The array of evacuation ports can be located in the first plane, such that at least one evacuation port is adjacent to each vaporization region. The vacuum source can be adapted for fluid communication with the evacuation ports. The array of purge gas ports can be located in the first plane such that at least one purge gas port is adjacent each vaporization region and on a side of the vaporization region opposite to the evacuation port adjacent to that vaporization region. The purge gas source can be adapted for fluid communication with the purge gas ports. In operation, the purge gas source and the vacuum source induce gas flows along flow paths extending through the vicinity of, and substantially parallel to, the vaporization regions and through the evacuation ports, sufficient to entrain and remove vapor located at or proximate to the vaporization regions. In some embodiments, the gas flow has a flow rate of from about 0.03 to about 1.5 standard liters per minute per drop of film-forming material, or from about 0.1 to about 0.8 standard liters per minute per drop of film-forming material. The purge gas port and the evacuation port can be sized such that the gas velocities in the ports are less than Mach 1.

According to various embodiments of the present teachings, an apparatus for drying a film-forming material in a carrier liquid and transferring the dried film-forming material to a substrate is provided. The apparatus can comprise a rotating drum film-forming apparatus, a film material delivery mechanism, a solvent vapor removal apparatus, a heater, and a material transfer apparatus. The rotating drum film-forming apparatus with a transfer surface can be configured for receiving and supporting the film-forming material in the carrier liquid at a first orientation, and depositing dried film-forming material onto a substrate at a second orientation. The film material delivery mechanism can be configured for metering out the film-forming material in the carrier liquid onto the transfer surface at a first orientation. The solvent vapor removal apparatus can be located adjacent to the transfer surface at an orientation intermediate between the first and second orientations, the solvent vapor removal apparatus comprising one or more evacuation ports and a vacuum source adapted for fluid communication with the one or more evacuation ports. The heater can be adapted to heat the transfer surface at the intermediate orientation. The material transfer apparatus at the second orientation can be configured for transferring the substantially dry film-forming material to the substrate. In operation, the film-forming material in carrier liquid can be metered out at the first orientation, heated and dried with removal of carrier liquid vapor via entrainment by a gas flow induced into the solvent vapor removal apparatus at the intermediate orientation, and transferred in substantially dry form to the substrate at the second orientation.

In some embodiments, the rotating drum film-forming apparatus comprises a faceted drum. The material transfer apparatus at the second orientation can comprise an optical source and optical path for transferring the film-forming material by heat. In some embodiments, the material transfer apparatus at the second orientation comprises a piezoelectric material for transferring the film-forming material by agitation. The gas flow can have a flow rate at the intermediate orientation of from about 0.03 to about 1.5 standard liters per minute per 10-picoliter metered-out portion of film-forming material, or from about 0.1 to about 0.8 standard liters per minute per 10-picoliter metered-out portion of film-forming material. In some embodiments, the solvent vapor removal apparatus is separated from the transfer surface by a distance of from 100 to 200 micrometers. A solvent trap can be provided in fluid communication with the one or more evacuation ports and the vacuum source. In some embodiments, the film-forming material includes OLED material.

According to various aspects of the present teachings, a method for forming a film is provided. The method can comprise one or more of the following steps. A droplet of a film-forming material is supported in a carrier liquid at a desired site, wherein the site defines a first plane. The carrier liquid is vaporized, thereby forming a carrier-liquid vapor in the vicinity of the site and substantially drying the film-forming material. A gas flow is established along a path extending away from the vicinity of the site, along a line substantially normal to the first plane. The carrier-liquid vapor is removed in the vicinity of the site by entraining it in the gas flow. The substantially dried film-forming material is transferred to a substrate, whereby a film is formed.

According to various embodiments of the present application, a method for forming a film is provided. The method can comprise one or more of the following steps. A droplet of a film-forming material is supported in a carrier liquid at a desired site, wherein the site defines a first plane. The carrier liquid is vaporized, thereby forming a carrier-liquid vapor in the vicinity of the site and substantially drying the film-forming material. A gas flow is established along a path in the vicinity of the site, along a line substantially parallel to the first plane. The carrier-liquid vapor in the vicinity of the site is removed by entraining it in the gas flow. The substantially dried film-forming material is transferred to a substrate, whereby a film is formed. In alternative inkjet applications, the film-forming material can be dried directly onto a substrate where it will be used, rather than be transferred.

In some embodiments, the step of transferring the substantially dried film-forming material to a substrate comprises vaporizing the substantially dried film-forming material, and contacting the vaporized film-forming material with a substrate. The film-forming material can include an organic light-emitting device material. A plurality of desired sites in the first plane can be included, each site supporting a droplet of film-forming material in a carrier liquid.

The present teachings provide apparatus and methods for removing carrier liquid vapor produced in printing a film of uniform thickness onto a substrate. The film-forming material can comprise an organic ink composition. The term “ink” as used in this disclosure is generally defined as any mixture having a volume of film-forming material (also called solid material or a solid portion) in a volume of carrier liquid (also called fluid component, carrier liquid, or carrier liquid) that together are in the liquid phase in a temperature range that is useful to the operation of the apparatus. Examples of such generalized “inks” include mixtures of solid particles suspended or dispersed in a carrier liquid, and solutions of solid materials in a carrier liquid. In some embodiments, the carrier liquid can be in a solid phase at ambient temperatures but in a liquid phase at higher temperatures useful during operation of the apparatus. The solid material is a solid at ambient temperatures, but in some embodiments can be in the liquid phase at higher temperatures that are used during operation of the apparatus. A significant characteristic of the carrier liquid in relation to the solid material is that the carrier liquid vaporizes at a lower temperature than the vaporization or sublimation temperature of the solid material, thus allowing selective vaporization of the carrier liquid.

During thermal printing applications, the carrier liquid is vaporized by heat on a transfer member during the film-forming process. The transfer member is a member that is adapted for receiving the film-forming material in the carrier liquid, and depositing dried film-forming material onto a substrate. In various embodiments, the transfer member can include a vaporization region that vaporizes the carrier liquid and can subsequently transfer the dried film-forming material to a desired target, for example, to a substrate. The present disclosure describes, among other things, various embodiments of the apparatus, including, for example, a solvent vapor removal apparatus for removing carrier liquid vapor and for preventing or mitigating the carrier liquid vapor from condensing elsewhere on the apparatus or substrate.

In various embodiments of the apparatus, a solvent vapor removal apparatus is located over the vaporization region, that is, substantially normal to the vaporization region. The solvent vapor removal apparatus includes one or more evacuation ports located over a vaporization region on which a quantity of the ink composition has been provided. The quantity of ink can be, for example, a drop on the order of from 10 to 200 micrometers in diameter, the vaporization region can have a diameter on the order of 200 micrometers, and the one or more evacuation ports can be on the same order of diameter as the vaporization region. The vaporization region on which the ink composition is placed can be sufficiently hot so as to vaporize the carrier liquid. Alternatively, the vaporization region can first be at a temperature at which the carrier liquid is not substantially vaporized and then subsequently be heated to a temperature sufficient to vaporize the carrier liquid. The vaporization region can be directly heated or heated by an external source. The one or more evacuation ports of the solvent vapor removal apparatus are in communication with a vacuum source that serves to draw gas flow through the evacuation port of the solvent vapor removal apparatus in a direction substantially normal to the vaporization region. This action also entrains the carrier liquid vapor and draws it through the evacuation port. According to various embodiments, the solvent vapor removal apparatus design can also include a solvent trap or chiller located in the path between the evacuation port and the vacuum source, for the purpose of removing carrier liquid vapor, recovering vaporized liquid, and preventing contamination of the vacuum source. Considerations that are noteworthy for the effectiveness of this apparatus include: the location of the gas flow, which should be close to the source of the carrier liquid vapor; the gas flow direction, which should be directed to carry the carrier liquid vapor away from the film-forming apparatus before any recondensation can take place; and the flow rate, which should be sufficient to prevent carrier liquid vapor molecules from escaping or returning to the vaporization region or to other parts of the film-forming apparatus while not disrupting the film-forming process. In one non-limiting example, the ink drop diameter can be up to 200 micrometers, for example, from 10 to 100 micrometers, the solvent vapor removal apparatus evacuation port can have a diameter within a range of from 50 to 300 micrometers, the evacuation port can be placed at a gap of from 50 to 200 micrometers above the heated ink drop, and the gas flow rate can be in the range of from 0.1 to 1.5 standard liters per minute (slm).

In various embodiments, the evacuation port and solvent vapor removal apparatus can be in a fixed position relative to the vaporization region. In other embodiments, the evacuation port and solvent vapor removal apparatus can be in a temporary orientation relative to the vaporization region. In this disclosure, the term “in a temporary orientation” or “in a temporary relationship” shall mean that the respective elements are movable relative to one another. Relative movement can be provided to move the evacuation port into and out of the relationship with the vaporization region. Such embodiments allow the removal of carrier liquid vapor in one orientation while also allowing ink loading or discharging in other orientations.

In a variety of embodiments, multiple units of the above solvent vapor removal apparatus can be arranged in an array to accommodate a film-forming apparatus capable of providing and heating multiple drops of ink simultaneously in an array.

In further embodiments, this disclosure provides the above solvent vapor removal apparatus as part of a rotating or moving system having at least one transfer surface which is supplied with film-forming material in one orientation and delivers film-forming material to a substrate at a second orientation, such that film-forming material deposits on the substrate in substantially the solid phase. The film-forming material supplied in the first orientation can be an ink as described above, that is, a solid film-forming material provided in a carrier liquid. A solvent vapor removal station can be provided between the first and second orientations to enable a means for removing the carrier liquid by vaporization, which can be accomplished by heating the transfer surface of the rotating system. The solvent vapor removal station can be an evacuation port or an array of evacuation ports, in communication with a vacuum source and in close proximity to the surface of the rotating mechanism. Such an arrangement can serve to draw gas and carrier liquid vapor through the evacuation ports. It thus serves the purpose of substantially reducing or preventing carrier liquid vapor molecules from escaping or from recondensing on the heated surface or on another part of the film-forming apparatus, and from contaminating the final desired film.

In various embodiments, this disclosure provides an apparatus in which a purge flow of gas is provided over and parallel to the vaporization region. The apparatus can include, for example, an evacuation port placed in proximity to the vaporization region and in or near the plane defined by the vaporization region. The quantity of ink can be a drop on the order of 10 picoliters in volume up to 200 micrometers in diameter, and typically from 10 to 100 micrometers in diameter. The gas flow outlet can be on the same order of diameter as that of the vaporization region, that is, from about 50 to about 300 micrometers. It will be understood that ink drop volumes can be larger or smaller, and that modifications of the size and placement of elements of this disclosure based upon drop size can be made by those skilled in the art based on the teachings of this disclosure.

The vaporization region on which the ink composition is placed can be sufficiently hot to vaporize the carrier liquid, or it can first be at a temperature at which the carrier liquid is not substantially vaporized and then subsequently be heated to a temperature sufficient to vaporize the carrier liquid. The evacuation port is in communication with a vacuum source that serves to draw gas flow through the evacuation port. A purge gas port is placed in proximity to the vaporization region in or near to the plane defined by the vaporization region, at the opposite side of the ink and vaporization region to the evacuation port. The diameter of the purge gas port should be from 50 to 300 micrometers. A purge gas is supplied to the purge gas port. The separation between the ink and the purge gas port, and the ink and the evacuation port, is on the order of 200 micrometers or less. The combination of purge gas supplied to the purge gas port and a vacuum source in communication with the evacuation port causes the gas to flow over the vaporization region and ink, in a direction parallel to the vaporization region, and draws the carrier liquid vapor away from the region above the ink and to the evacuation port. This reduces or eliminates the likelihood of carrier liquid vapor from escaping or returning to the vaporization region or other part of the film-forming apparatus and from contaminating the final desired film. The gas flow rate can be in the range of from 0.1 to 1.5 standard liters per minute. The evacuation port design can also include a solvent trap located in the path between the evacuation port and the vacuum source, for the purpose of removing carrier liquid vapor and preventing contamination of the vacuum source. Considerations that are noteworthy for this apparatus include: the location of the gas flow, which should be close to the source of the carrier liquid vapor; the gas flow should be so directed as to carry the carrier liquid vapor in a direction away from the film-forming apparatus before any recondensation can take place; and that the flow rate is sufficient to prevent carrier liquid vapor molecules from escaping or returning to the transfer surface or to another part of the film-forming apparatus while not disrupting the film-forming process.

In some embodiments, multiple units of the above apparatus can be arranged in an array to accommodate a film-forming apparatus capable of providing and heating multiple drops of ink in an array, simultaneously.

In various embodiments, the above-described gas-flow arrangement is part of a printhead mechanism. For example, a drop of ink including a carrier liquid can be supplied to a vaporization region. The vaporization region can include micropores, micro-pillars, micro-channels, or other micro-patterned structures. The carrier liquid is vaporized substantially over the vaporization region. Gas flow from a purge gas port to an evacuation port passes above the ink and draws the carrier liquid vapor away from the region above the ink and to the evacuation port. This reduces or eliminates the likelihood of carrier liquid vapor from escaping or returning to the vaporization region or to another part of the film-forming apparatus. The film-forming material can then be transferred to a substrate.

In a variety of embodiments, methods for removing carrier liquid vapor produced by heating an ink are provided. According to various embodiments, the method can include the steps of: supporting a droplet of a film-forming material in a carrier liquid at a desired site, wherein the site defines a first plane; vaporizing the carrier liquid, thereby forming a carrier-liquid vapor in the vicinity of the site and substantially drying the film-forming material; establishing a gas flow along a path extending away from the vicinity of the site, along a line substantially normal to the first plane; removing the carrier-liquid vapor in the vicinity of the site by entraining it in the gas flow; and transferring the substantially dried film-forming material to a substrate, whereby a film is formed. According to other embodiments, the method can include the steps of: supporting a droplet of a film-forming material in a carrier liquid at a desired site, wherein the site defines a first plane; vaporizing the carrier liquid, thereby forming a carrier-liquid vapor in the vicinity of the site and substantially drying the film-forming material; establishing a gas flow along a path in the vicinity of the site, along a line substantially parallel to the first plane; removing the carrier-liquid vapor in the vicinity of the site by entraining it in the gas flow; and transferring the substantially dried film-forming material to a substrate, whereby a film is formed. The film material deposited onto the substrate can have a patterned shape or can be a uniform coating over the entire deposition area.

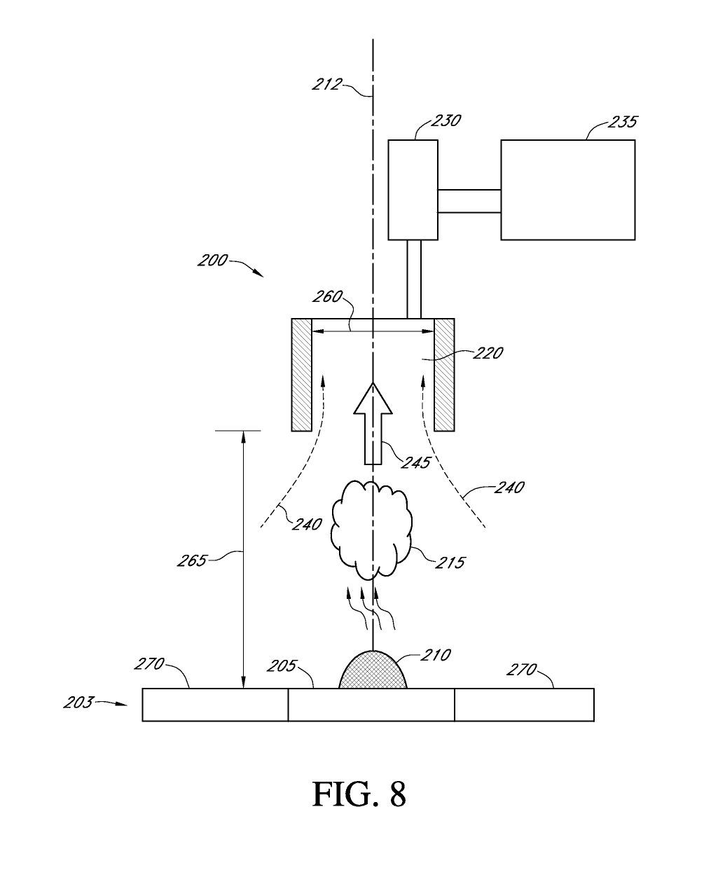

FIG. 8 schematically illustrates an apparatus for drying a film-forming material in a carrier liquid according to an embodiment of this disclosure. The solvent vapor removal apparatus 200 comprises evacuation port 220 and vacuum source 235. Vacuum source 235 is adapted for fluid communication with evacuation port 220 to induce a flow of gas (e.g. gas flow 240) through evacuation port 220 to vacuum source 235. Gas flow 240 can come from the surrounding environment, e.g. air. In some embodiments, solvent vapor removal apparatus 200 can also include solvent trap 230.

The apparatus for drying a film-forming material in a carrier liquid further includes a transfer member 203. In some useful embodiments, transfer member 203 has a vaporization region 205 and a non-vaporization region 270. A vaporization region 205 is defined at least in part by a surface portion of transfer member 203, and vaporization region 205 defines a first plane. In a variety of embodiments, transfer member 203 can also include a non-vaporization region 270. Vaporization region 205 is configured to support a portion of the film-forming material in the carrier liquid, as shown by ink 210. Evacuation port 220 is located adjacent to vaporization region 205, such that evacuation port 220 intersects a line 212 that extends away from vaporization region 205 in a direction substantially normal to the plane defined by vaporization region 205. For simplicity of explanation in this disclosure, evacuation port 220 can be described as being “over” or “located over” vaporization region 205. It will be understood that the terms “over” and “located over” refer in this context to the positions of evacuation port 220 and vaporization region 205 relative to each other, regardless of the absolute orientation of those features.

Transfer member 203 can be an apparatus or part of an apparatus for depositing an organic material as a film onto a substrate. Transfer member 203 can be an apparatus or part of an apparatus for depositing an organic light-emitting diode film onto a substrate. Such an apparatus, which is also called a thermal jet printer or thermal jet printing apparatus, is described in U.S. Patent Application Publications Nos. US 2008/0308037 A1, US 2008/0311307 A1, US 2010/0171780 A1, and US 2010/0188457 A1, the contents of which are incorporated herein in their entireties by reference. Vaporization region 205 can be an unpatterned surface, or can contain micro-patterned surface features, such as micropores, micro-pillars, micro-channels that extend from a first opening through transfer member 203 to a second opening formed on a second opposing face of the transfer member, or other micro- or nano-patterned structures, and may further include arrays of such structures (interchangeably, micro-arrays). The apparatus for drying a film-forming material in a carrier liquid also includes a heater adapted to heat vaporization region 205. The heater (not shown) can be any heater well-known to those skilled in the art. In some non-limiting examples, in some embodiments a resistive-type heater designed to selectively heat vaporization region 205 can be incorporated into transfer member 203. In other embodiments, the heater can be a radiative-type heater, e.g. infrared or microwave, located over vaporization region 205 and designed to selectively heat vaporization region 205.

Ink 210 is deposited onto vaporization region 205. For the purposes of this disclosure, ink 210 is a mixture having a solid portion and a carrier liquid portion, wherein the carrier liquid portion vaporizes at a lower temperature than the solid portion. Examples of such generalized inks include mixtures of solid particles suspended in a carrier liquid and solutions of solid materials in a carrier liquid. The term “solids” is used to describe materials that are in the solid phase at normal ambient temperatures. The solid particles or dissolved solid materials comprise a film-forming material. In various embodiments of this disclosure, the solid materials of ink 210 comprise an organic light-emitting diode material that is deposited on a substrate as a film in substantially the solid phase. Vaporization region 205 can then be heated sufficiently to vaporize the carrier liquid in ink 210, thus forming carrier liquid vapor 215 over vaporization region 205. Ink 210, which after evaporation consists essentially of its constituent solid material, can then be discharged in a subsequent step by such methods as, for example, a momentary pulse of additional heating to a higher temperature, a piezoelectric pulse, or a gas discharge.

Vacuum source 235 is adapted for fluid communication with evacuation port 220 and induces gas flow 240 from vaporization region 205 into evacuation port 220. Gas flow 240 is sufficient to entrain carrier liquid vapor 215, and remove carrier liquid vapor 215 that is located at or proximate to vaporization region 205, which brings carrier liquid vapor 215 also into evacuation port 220, as illustrated by carrier liquid vapor flow 245. Evacuation port 220 has an aperture diameter 260 and a separation distance 265 from vaporization region 205. The location of evacuation port 220 relative to vaporization region 205 can be fixed, or it can be a temporary relationship. The latter will be made clear in further embodiments of this disclosure. In one embodiment of this disclosure, aperture diameter 260 and separation distance 265 are on the same order of magnitude as the diameter of vaporization region 205. In some useful embodiments, aperture diameter 260 is in the range of from 50 to 300 micrometers, and separation distance 265 is in the range of from 100 to 200 micrometers, while the diameter of vaporization region 205 is 200 micrometers or less. Considerations that are noteworthy in tuning performance of this apparatus include the location of gas flow 240, which in various embodiments should be close to the source of carrier liquid vapor 215. Gas flow 240 should function to carry carrier liquid vapor 215 away from the transfer surface of a film-forming apparatus such as vaporization region 205 before any recondensation can take place. Gas flow 240 can be air from the environment of the apparatus. The gas flow rate is sufficient to prevent carrier liquid vapor molecules from escaping or returning to vaporization region 205 or other part of the film-forming apparatus, while not being so great as to disrupt the film-forming process, e.g. by distorting ink drop 210 before the carrier liquid evaporates. In one embodiment, for example, ink drop 210 has a volume on the order of 10 picoliters and a diameter of up to 200 micrometers and typically in the range of from 10 to 100 micrometers. In this embodiment, good purge conditions can be obtained when evacuation port 220 has an aperture diameter 260 of approximately 300 micrometers, separation distance 265 is 200 micrometers or less, and the gas flow rate is from 0.1 to 1.5 standard liters per minute.

Further theoretical and practical considerations are considered in determining the optimum separation distance, aperture diameter, and gas flow rate, as well as interactions among these factors. Separation distance 265 can be sufficient to allow air flow between transfer member 203 and evacuation port 220. This can be accomplished by making separation distance 265 greater than the mean free path of the air molecules at the operating pressure of the apparatus. At ambient pressure, this is less than 0.1 micrometers, so that a separation distance 265 greater than this will permit non-viscous air flow. A practical consideration, however, is the desire to avoid collision of transfer member 203 with evacuation port 220 by setting a minimum value for separation distance 265. Significant factors to consider include manufacturing tolerances, apparatus vibration during operation, and movement of parts relative to one another in embodiments wherein the transfer member 203 and evacuation port are in a temporary relationship to one another. Although the exact nature of these factors can determine what the minimum value for separation distance 265 is in a given system, a general minimum of from 50 to 100 micrometers can be specified. The maximum value of separation distance 265 is determined by effectiveness of the apparatus. It has been determined that carrier liquid vapor 215 can be substantially removed when separation distance 265 is 200 micrometers or less.

The volume of ink drop 210 is typically on the order of 10 picoliters. For substantial removal of carrier liquid vapor 215, the rate of gas flow 240 should be at least 0.03 standard liters per minute (slm), and good results are obtained with 0.1 standard liters per minute or greater. Aperture diameter 260 should be sufficient that the linear velocity of gas flow through the aperture is less than Mach 1, the speed of sound (approximately 340 m/s at atmospheric pressure). This leads to a desirable minimum aperture diameter of approximately 50 micrometers to support a flow rate of 0.03 slm, and a desirable minimum diameter of approximately 100 micrometers to support a flow rate of 0.1 slm. The maximum aperture diameter 260 is determined by considering geometry, and in particular by the size and spacing of multiple ink drops 210, and therefore the allowable distance between multiple evacuation ports 220, as in some embodiments disclosed herein (below). A practical maximum aperture diameter 260 is 300 micrometers, which leads to a maximum gas flow rate of 1.5 slm for embodiments wherein a single evacuation port 220 is designed to remove carrier liquid vapor from a single ink drop 210.

It should be appreciated that vaporization region 205 often does not exist in isolation, but as part of a larger apparatus, of which many parts may not be heated. For example, non-vaporization region 270 can surround vaporization region 205. Ink is not provided to non-vaporization region 270, nor is non-vaporization region 270 heated. Thus, even if carrier liquid vapor 215 does not recondense on vaporization region 205, it may recondense on another part of the apparatus of which vaporization region 205 is a part. If carrier liquid vapor 215 did recondense near vaporization region 205, it could vaporize with the solid portion of ink 210 and contaminate the desired film. Substantial removal of carrier liquid vapor 215 by solvent vapor removal apparatus 200 can significantly reduce or eliminate these problems.

Vacuum source 235 can be any vacuum source well-known to those skilled in the art that can produce the air flow rates disclosed herein. Solvent trap 230 can be e.g. a cold trap that can condense carrier liquid vapor even under reduced pressure. Whether solvent trap 230 is desirable will be determined, for example, by the properties of carrier liquid vapor 215 and the properties and mode of operation of vacuum source 235.

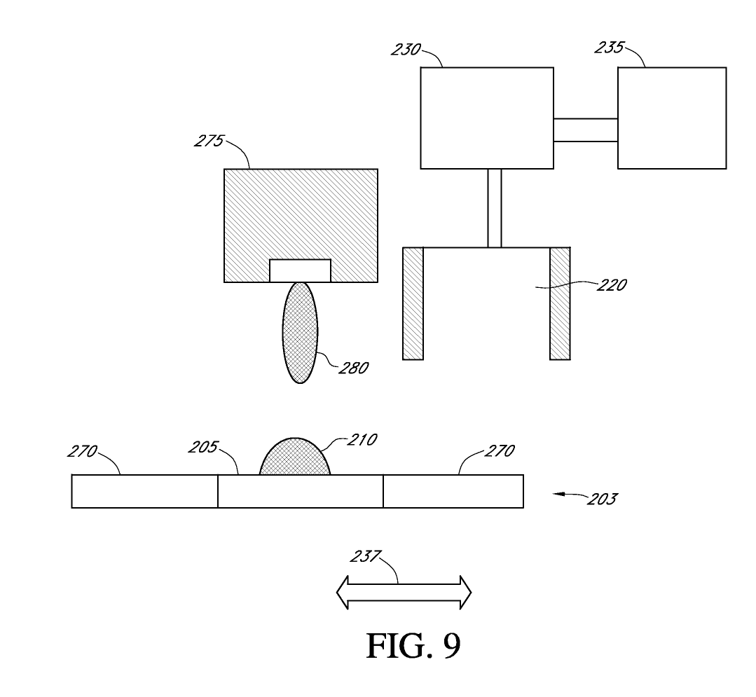

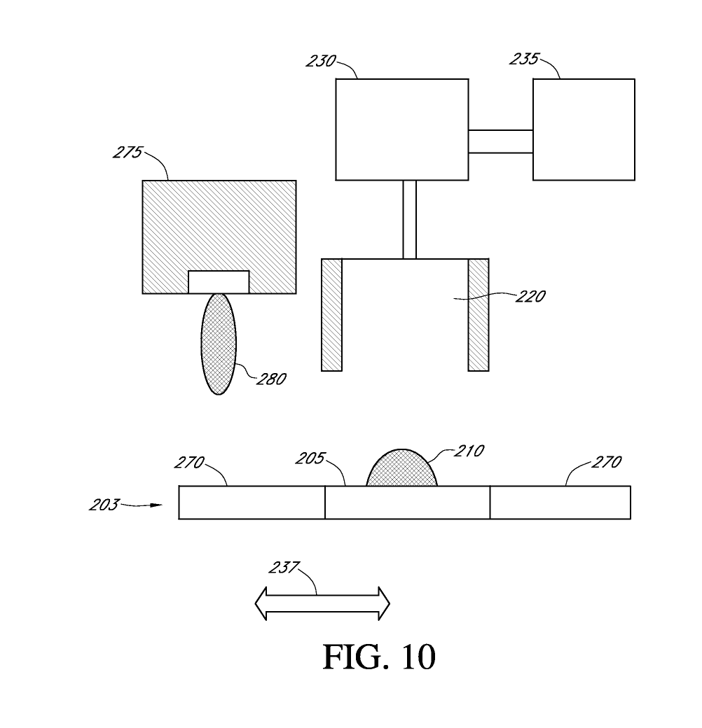

FIG. 9 schematically illustrates a solvent vapor removal apparatus that can be in a temporary relationship with a vaporization region according to other various embodiments of this disclosure. FIG. 10 illustrates the same apparatus, but at a different point in time. The solvent vapor removal apparatus is as described above for FIG. 8, comprising an evacuation port 220 in fluid communication with a vacuum source 235, and, in some embodiments, a solvent trap 230. In this apparatus, the solvent vapor removal apparatus is part of a printhead mechanism that includes ink source 275. Vaporization region 205 is also part of the printhead mechanism, and can move relative to the ink source and solvent vapor removal apparatus, as shown by arrow 237. In FIG. 9, vaporization region 205 is in an ink loading position. Ink 280 can be provided by ink source 275 to form ink 210 on vaporization region 205. Relative motion can then be provided wherein vaporization region 205 is removed from the ink loading position of FIG. 9 and placed in an ink vaporization position as shown in FIG. 10, as shown by arrow 237. In the ink vaporization position of FIG. 10, ink 210 can be heated to form carrier liquid vapor, and the carrier liquid vapor at or proximate to vaporization region 205 can be substantially removed by evacuation port 220, as described above for FIG. 8.

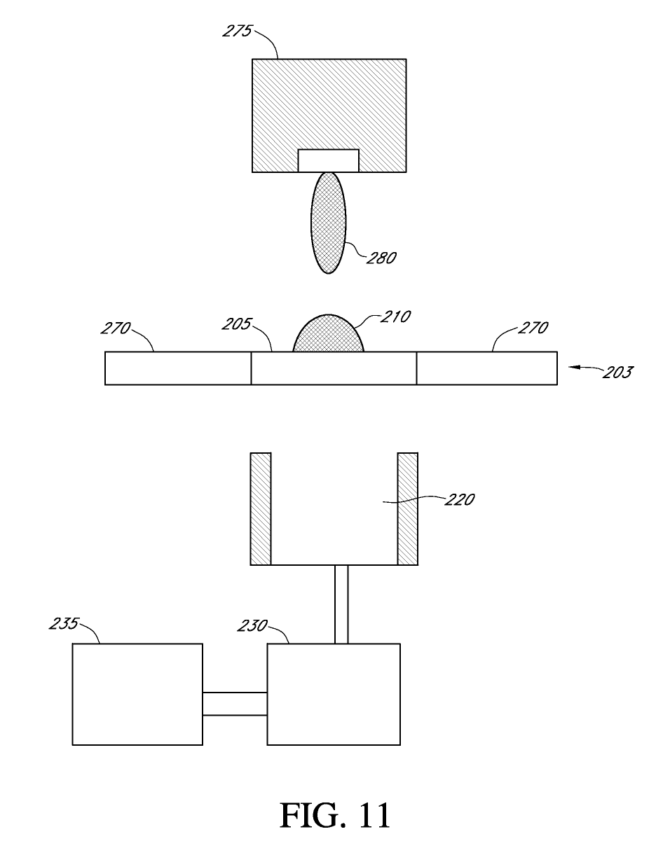

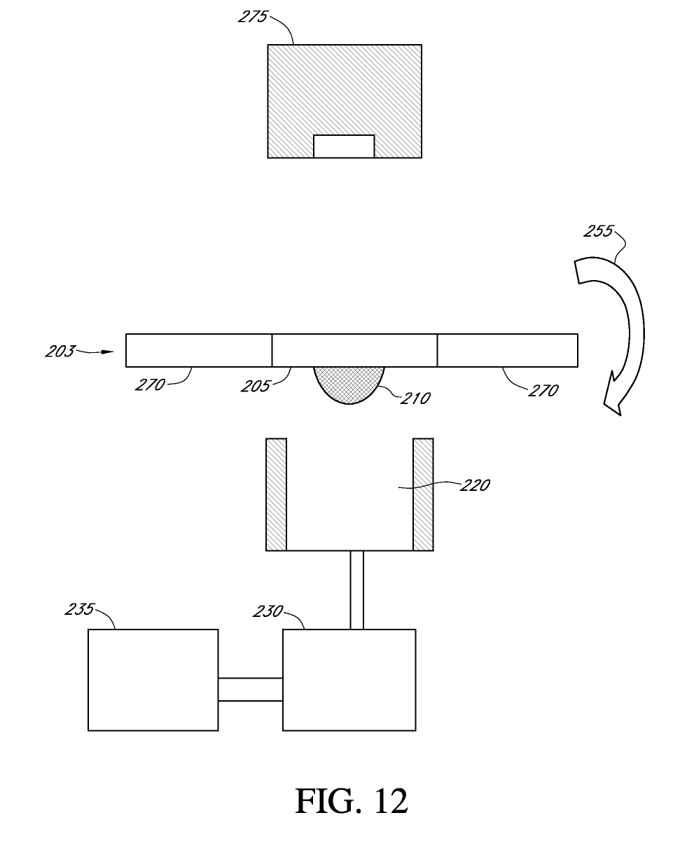

FIG. 11 schematically illustrates a solvent vapor removal apparatus that can be in a temporary relationship with a vaporization region according to other various embodiments of this disclosure. FIG. 12 illustrates the same apparatus, but at a different point in time. The solvent vapor removal apparatus is as described above for FIG. 8, comprising an evacuation port 220 in fluid communication with a vacuum source 235, and, in some embodiments, a solvent trap 230. This apparatus also includes an ink source 275. Transfer member 203 can rotate relative to the ink source and solvent vapor removal apparatus. In FIG. 11, vaporization region 205 is in an ink loading position. Ink 280 can be provided by ink source 275 to form ink 210 on vaporization region 205. Transfer member 203 is then rotated, as shown by arrow 255, from the ink loading position of FIG. 11 and placed in an ink vaporization position as shown in FIG. 12. In this position, ink 210 can be heated to form carrier liquid vapor, and the carrier liquid vapor at or proximate to vaporization region 205 can be substantially removed by evacuation port 220, as described above for FIG. 8.

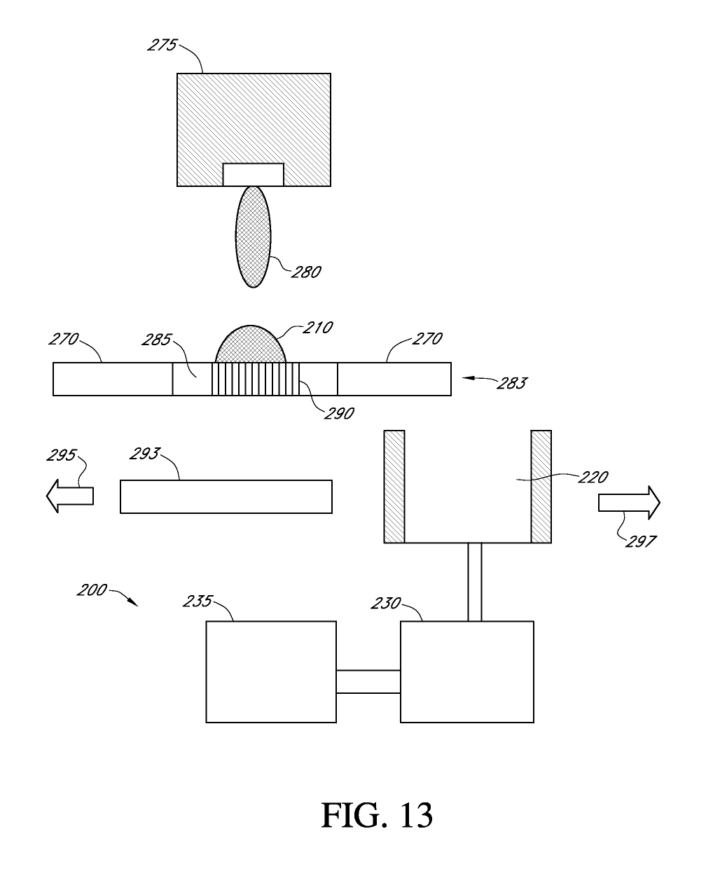

FIG. 13 schematically illustrates a solvent vapor removal apparatus that can be in a temporary relationship with a vaporization region according to other various embodiments of this disclosure. The solvent vapor removal apparatus 200 is as described above for FIG. 8, comprising an evacuation port 220 in communication with a vacuum source 235, and, in some embodiments, a solvent trap 230. In this apparatus, the solvent vapor removal apparatus 200 can move relative to the vaporization region. Transfer member 283 is part of a printhead mechanism, and has an array of pores 290 in vaporization region 285, as disclosed in U.S. Patent Application Publication No. US 2008/0308037 A1. Pores 290 are first openings on a first face of transfer member 283 with channels extending from the first openings, through transfer member 283, to second openings on a second, opposing face of transfer member 283. Ink 280 can be provided by ink source 275 to form ink 210 at vaporization region 285. Pores 290 allow ink 210 to pass through transfer member 283 and ultimately be deposited on substrate 293. Solvent vapor removal apparatus 200 and substrate 293 can be moved relative to transfer member 283, as indicated by arrow 295, into a position normal to vaporization region 285, and then ink 210 can be heated to form carrier liquid vapor that can be substantially removed by evacuation port 220, as described above for FIG. 8. Subsequently, solvent vapor removal apparatus can then be moved back to the non-vapor-removal position shown in FIG. 13, as indicated by arrow 297, and ink 210 can then be transferred to substrate 293 to form a film substantially free of carrier liquid contamination.

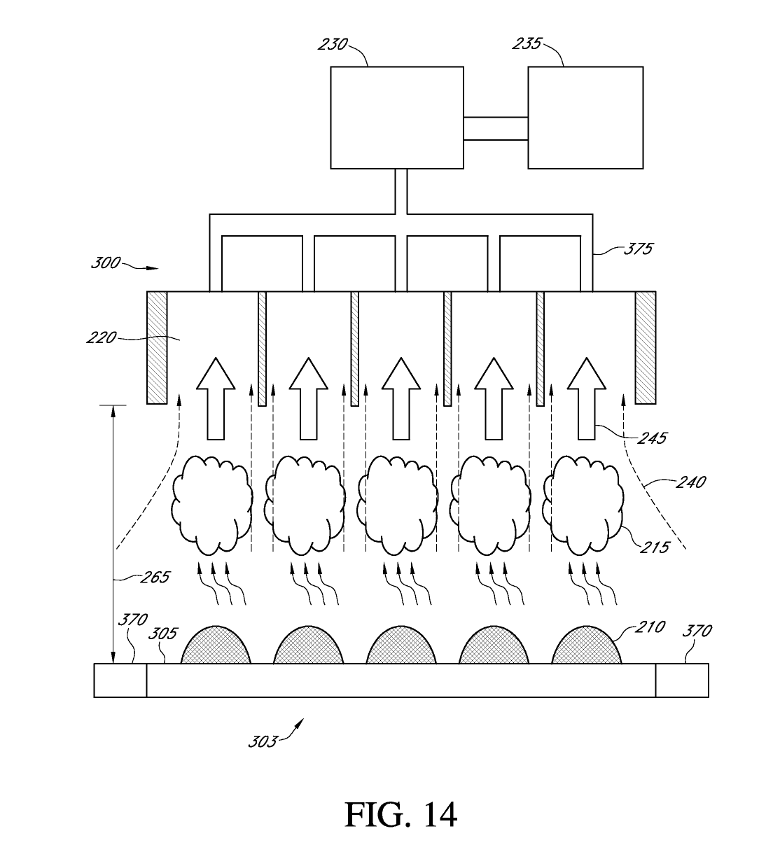

FIG. 14 schematically illustrates an apparatus for drying a film-forming material in a carrier liquid according to various embodiments of this disclosure wherein the solvent vapor removal apparatus comprises multiple units of the solvent vapor removal apparatus of FIG. 8. Solvent vapor removal apparatus 300 comprises multiple evacuation ports 220, and vacuum source 235 adapted for fluid communication with evacuation ports 220 via manifold 375 to induce a gas flow through evacuation ports 220 to vacuum source 235. Solvent vapor removal apparatus 300 can also include solvent trap 230 in some embodiments.

Transfer member 303 is an apparatus for depositing an organic material as a film onto a substrate and can be an apparatus for depositing an OLED film onto a substrate, for example, one described in one or more the reference patent publication applications referred to herein. Transfer member 303 can be one vaporization region 305, as shown, on which an array of drops of ink 210 are deposited, and bordered by non-vaporization region 370. In other embodiments, transfer member 303 can comprise an array of smaller vaporization regions (e.g. vaporization region 205 of FIG. 8), wherein ink 210 can be deposited onto each of the array of vaporization regions and the array of vaporization regions are separated by non-vaporization regions. Said array of ink drops can comprise a one-dimensional array of ink 210, as shown, or a two-dimensional array of ink 210. The array can include any number of drops of ink 210, and can be in any pattern desirable, e.g. square, rectangular, circular, triangular, chevron-shaped, or other desirable shape. Solvent vapor removal apparatus 300 comprises an array of evacuation ports corresponding in number, array size, and array shape to the array of drops of ink 210. Evacuation ports 220 of solvent vapor removal apparatus 300 are located over vaporization region 305. The location of evacuation ports 220 relative to vaporization region 305 can be fixed, or it can be a temporary relationship as in, for example, FIGS. 9 to 13 above. In various embodiments of this disclosure, the diameter of evacuation ports 220 and the separation distance between evacuation ports 220 and vaporization region 305 are on the same order of magnitude as the diameter of ink drop 210, and the gas flow rate is from 0.1 to 1.5 standard liters per minute, as disclosed above. The ink drops 210 can be up to 200 micrometers in diameter, and typically are from 10 to 100 micrometers in diameter. The evacuation ports 220 can have a diameter within a range of from 50 to 300 micrometers, and the separation distance 265 can be 200 micrometers or less.

Ink 210 is received onto vaporization region 305. Vaporization region 305 can then be heated sufficiently to vaporize the carrier liquid in ink 210, thus forming carrier liquid vapor 215 above vaporization region 305 and ink 210. Ink 210, which after evaporation consists essentially of its constituent solid material, can then be discharged in a subsequent step. Vacuum source 235 is adapted for fluid communication with evacuation ports 220 and causes gas to flow into evacuation ports 220, as shown by gas flow 240 (dashed lines). Gas flow 240 extending from vaporization region 305 through evacuation ports 220 is sufficient to entrain carrier liquid vapor 215 also into evacuation ports 220, as shown by carrier liquid vapor flow 245, thus removing carrier liquid vapor 215 located at or proximate to vaporization region 305 before any recondensation of the carrier liquid vapor can take place. Gas flow 240 can be supplied by the environment surrounding the apparatus. Substantial removal of carrier liquid vapor 215 by solvent vapor removal apparatus 300 can significantly reduce or eliminate the problem of carrier liquid vapor recondensing onto the film-forming apparatus.

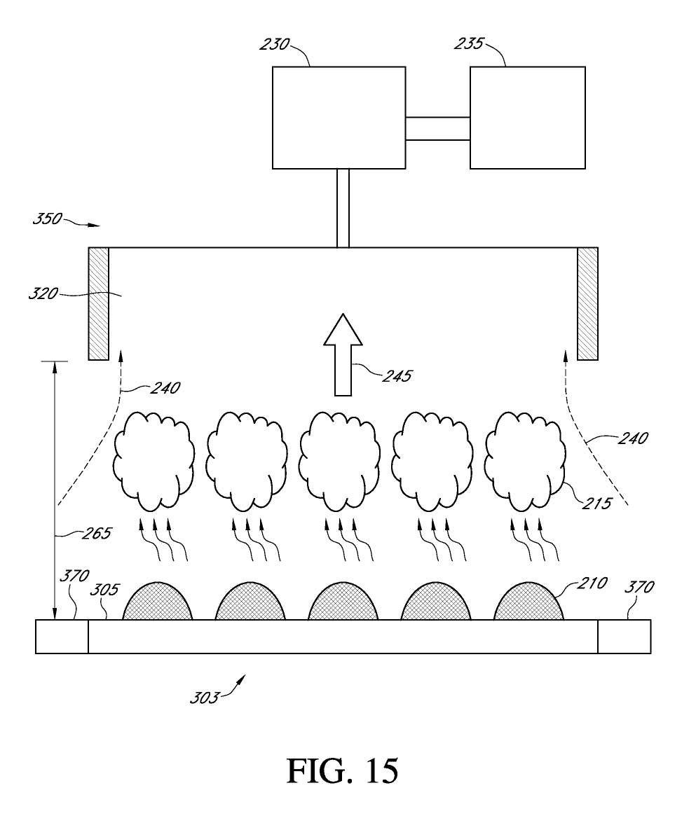

FIG. 15 schematically illustrates a solvent vapor removal apparatus according to various embodiments of this disclosure wherein the solvent vapor removal apparatus comprises a larger unit of the solvent vapor removal apparatus of FIG. 8. Solvent vapor removal apparatus 350 comprises evacuation port 320, and vacuum source 235 adapted for fluid communication with evacuation port 320 to induce a gas flow through evacuation port 320 to vacuum source 235. Solvent vapor removal apparatus 350 can also include solvent trap 230.

Transfer member 303 is an apparatus for depositing an organic material as a film onto a substrate as disclosed above for FIG. 14. Evacuation port 320 corresponds in size and shape to the array of drops of ink 210. Evacuation port 320 of solvent vapor removal apparatus 350 is located over vaporization region 305. The location of evacuation port 320 relative to vaporization region 305 can be fixed, or it can be a temporary relationship as in, for example, FIGS. 9 to 13. In various embodiments of this disclosure, the separation distance between evacuation port 320 and vaporization region 305 is on the same order of magnitude as the diameter of ink drop 210, as disclosed above. The ink drops 210 can be up to 200 micrometers in diameter, and typically are from 10 to 100 micrometers in diameter. The separation distance 265 is 200 micrometers or less. The gas flow rate can be from 0.03 to 1.5 standard liters per minute (slm) per ink drop 210, and desirably from 0.1 to 0.8 slm per ink drop 210.

Ink 210 is received onto vaporization region 305. Vaporization region 305 can then be heated sufficiently to vaporize the carrier liquid in ink 210, thus forming carrier liquid vapor 215 above vaporization region 305 and ink 210. Ink 210, which after evaporation consists essentially of its constituent solid material, can then be discharged in a subsequent step. Vacuum source 235 is adapted for fluid communication with evacuation port 320 and causes gas to flow into evacuation port 320, as shown by gas flow 240. Gas flow 240 extending from vaporization region 305 through evacuation port 320 is sufficient to entrain carrier liquid vapor 215 also into evacuation port 320, as shown by carrier liquid vapor flow 245, thus removing carrier liquid vapor 215 located at or proximate to vaporization region 305 before any recondensation of the carrier liquid vapor can take place. Gas flow 240 can be supplied by the environment surrounding the apparatus. Substantial removal of carrier liquid vapor 215 by solvent vapor removal apparatus 350 can significantly reduce or eliminate the problem of carrier liquid vapor recondensing onto the film-forming apparatus.

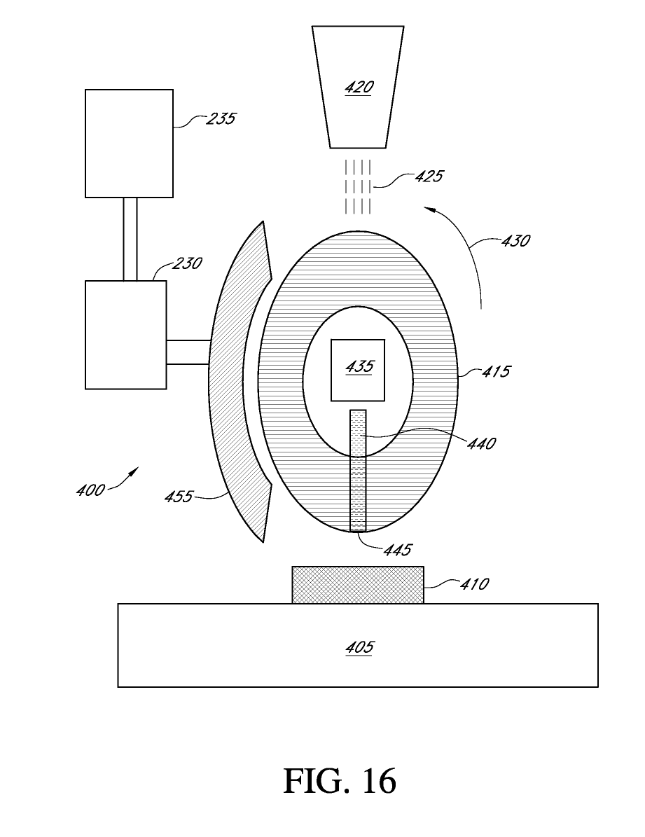

FIG. 16 schematically illustrates a solvent vapor removal apparatus as a part of a rotating drum film-forming apparatus according to a variety of embodiments of this disclosure. Such a rotating drum film-forming apparatus, without a solvent vapor removal apparatus, has been disclosed in detail by U.S. Patent Application Publication No. US 2011/0293818 A1, the contents of which are incorporated herein in their entirety by reference. As disclosed by that publication, a rotating drum 415 has a transfer surface, which can be equivalent to the vaporization region of other embodiments of this disclosure. Film material delivery mechanism 420 meters out film material 425, which can be a film-forming material in a carrier liquid as disclosed herein, onto the transfer surface of rotating drum 415. The metered out film material 425 can be metered as one or more droplets or as a stream. In one example, film material 425 can be delivered as a liquid ink and can deposit on the transfer surface of rotating drum 415 in the liquid phase. The transfer surface of rotating drum 415 can function to receive the metered film material 425 in a first orientation and then transfer it in a second orientation onto a deposition surface, e.g. a substrate 405. The metered film material 425 received on the transfer surface of rotating drum 415 in the first orientation is moved towards substrate 405 and into the second orientation by the rotation of the drum as shown by arrow 430. In the second orientation, metered film material 425 that is on the transfer surface of rotating drum 415 can be dislodged, by means such as agitation or pressure, e.g. from an integrated piezoelectric material, or by heat such as from optical source 435 and optical path 440 onto optically excited region 445 to form deposited film 410 on substrate 405.

As one embodiment, U.S. Patent Application Publication No. US 2011/0293818 A1 discloses a conditioning unit, at the first orientation, the second orientation, or a different intermediate orientation, to purge material that is not part of deposited film 410, e.g. carrier liquid from the ink. The conditioning unit disclosed in that publication can be a heat and/or gas source, and can transmit radiation, convection, or conduction heating to the transfer surface. In various circumstances, heat alone, however, may not necessarily sweep the carrier liquid vapor away, and a gas may simply sweep it to a different part of the system. In such circumstances, the carrier liquid vapor may not be sufficiently removed and may recondense, e.g. at a different location of the transfer surface of rotating drum 415, or at a different part of the deposition system.

In FIG. 16, the placement of solvent vapor removal apparatus 400 at an intermediate orientation in close proximity to the transfer surface of rotating drum 415 can reduce or eliminate carrier liquid vapor recondensation. Evacuation port structure 455 of solvent vapor removal apparatus 400 can include an evacuation port 220 as in above solvent vapor removal apparatus 200, an array of such evacuation ports as in above solvent vapor removal apparatus 300, a larger evacuation port 320 as in above solvent vapor removal apparatus 350, or even an array of such larger evacuation ports, located adjacent to and over the transfer surface of rotating drum 415. The separation distance between the inner surface of evacuation port structure and the transfer surface of rotating drum 415 is 300 micrometers or less. Solvent vapor removal apparatus 400 also includes a vacuum source 235 as disclosed above, and can also include a solvent trap 230. Ink that has been deposited onto the transfer surface of rotating drum 415 is positioned in a temporary relationship with solvent vapor removal apparatus 400 by the rotation of rotating drum 415. Heat is supplied to the ink, e.g. by one or more heaters in rotating drum 415 or by one or more heaters in evacuation port structure 455. Thus the transfer surface of rotating drum 415 is equivalent to the vaporization region of other embodiments in this disclosure.

Heating of the ink forms carrier liquid vapor above the ink and above the transfer surface (vaporization region) of rotating drum 415. As described for other embodiments of this disclosure, the vacuum source of solvent vapor removal apparatus 400 is adapted for fluid communication with the evacuation port or ports of solvent vapor removal apparatus 400, which induces a gas flow extending from the adjacent transfer surface of rotating drum 415 through the evacuation port or ports. The gas flow is sufficient to entrain and remove the carrier liquid vapor located at or proximate to the adjacent transfer surface into the one or more evacuation ports of evacuation port structure 455, thus reducing or eliminating recondensation of the carrier liquid vapor in the system.

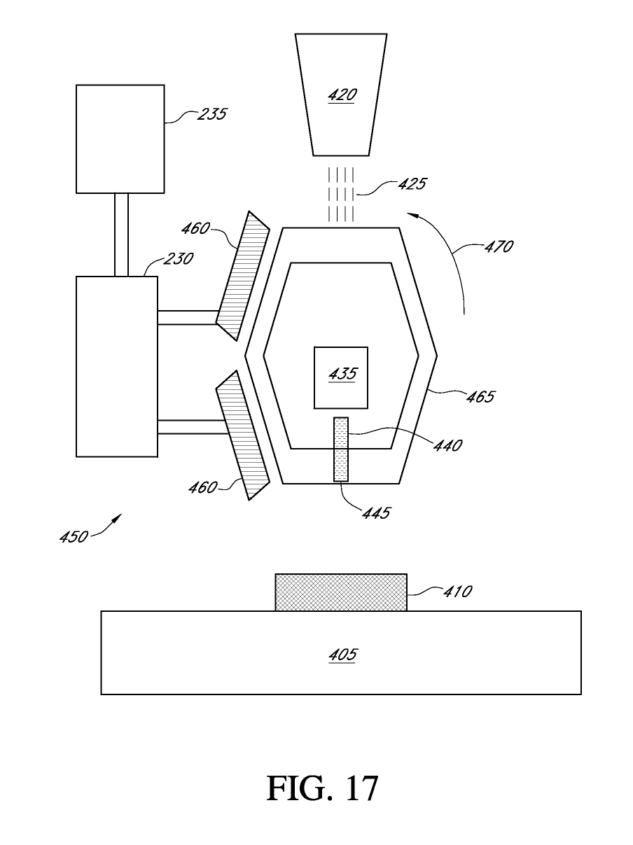

FIG. 17 schematically illustrates a solvent vapor removal apparatus as a part of a rotating faceted drum film-forming apparatus according to a variety of embodiments of this disclosure. Such a rotating faceted drum film-forming apparatus, without a solvent vapor removal apparatus, has been disclosed in U.S. Patent Application Publication No. US 2011/0293818 A1. A rotating faceted drum 465 has a series of transfer surfaces, each of which can be equivalent to the vaporization region of other embodiments of this disclosure. Film material delivery mechanism 420 meters out film material 425, which can be ink as disclosed herein, and which can be metered as one or more droplets. In one example, film material 425 can be delivered as a liquid ink and can deposit on the transfer surface of rotating faceted drum 465 in the liquid phase. The transfer surface of rotating faceted drum 465 can function to receive the metered film material 425 in a first orientation, the drum can rotate as shown by arrow 470, and the metered film material can then be transferred in a second orientation onto a deposition surface, e.g. a substrate 405, by means described above for rotating drum 415.

In FIG. 17, the placement of solvent vapor removal apparatus 450 at an intermediate orientation in close proximity to the transfer surface of rotating faceted drum 465 can reduce or eliminate carrier liquid vapor recondensation. Evacuation port structure 460 of solvent vapor removal apparatus 450 can include an evacuation port 220 as in above solvent vapor removal apparatus 200, an array of such evacuation ports as in above solvent vapor removal apparatus 300, a larger evacuation port 320 as in above solvent vapor removal apparatus 350, or even an array of such larger evacuation ports, located in close proximity to and over the transfer surface of rotating faceted drum 465. Solvent vapor removal apparatus 450 also includes a vacuum source 235 as disclosed above, and can also include a solvent trap 230. Ink that has been deposited onto the transfer surface of rotating faceted drum 465 is positioned in a temporary relationship with solvent vapor removal apparatus 450 by the rotation of rotating faceted drum 465. Heat is supplied to the ink, e.g. by one or more heaters in rotating faceted drum 465 or by one or more heaters in evacuation port structure 460. Thus the transfer surface of rotating faceted drum 465 is equivalent to the vaporization region of other embodiments in this disclosure. Heating of the ink forms carrier liquid vapor above the ink and above the transfer surface (vaporization region) of rotating faceted drum 465. As described for other embodiments of this disclosure, the vacuum source of solvent vapor removal apparatus 450 is adapted for fluid communication with the evacuation port or ports of solvent vapor removal apparatus 450, which induces a gas flow extending from the adjacent transfer surface of rotating faceted drum 465 through the evacuation port or ports. The gas flow is sufficient to entrain and remove the carrier liquid vapor located at or proximate to the adjacent transfer surface into the one or more evacuation ports of solvent vapor removal apparatus 450, thus reducing or eliminating recondensation of the carrier liquid vapor in the system.

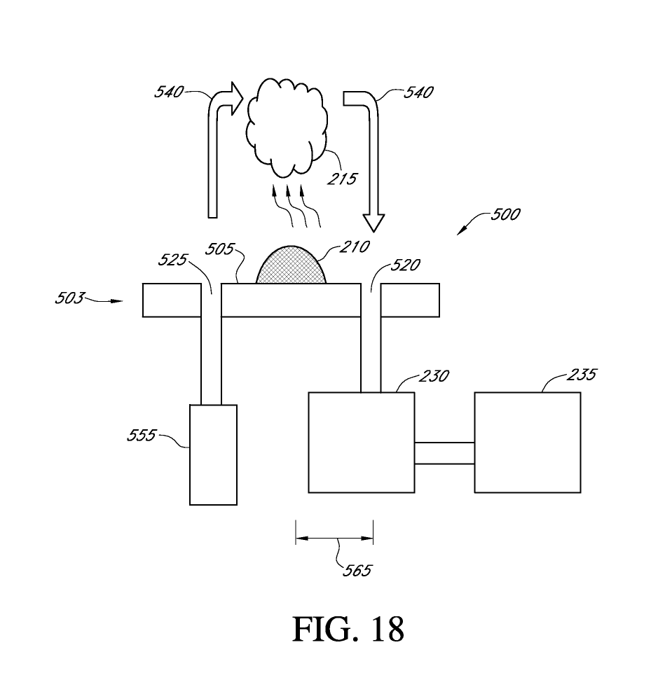

FIG. 18 schematically illustrates a solvent vapor removal apparatus that is part of a film-forming apparatus according to various embodiments of this disclosure. The film-forming apparatus 500 includes a transfer member 503 which has a vaporization region 505. Transfer member 503 is adapted for receiving film-forming material in carrier liquid, and depositing dried film-forming material onto a substrate. Vaporization region 505 is defined at least in part by a surface portion of transfer member 503 and is disposed along a first plane. Vaporization region 505 is configured to support a portion of film-forming material in a carrier liquid, e.g., ink 210. Transfer member 503 can further include a heater (not shown) adapted to heat vaporization region 505. Transfer member 503 further includes evacuation port 520 adjacent to vaporization region 505 and located in the first plane, and purge gas port 525 adjacent to vaporization region 505 and located in the first plane on the side of vaporization region 505 opposite to evacuation port 520. Vacuum source 235 is adapted for fluid communication with evacuation port 520, and purge gas source 555 is adapted for fluid communication with purge gas port 525. The purge gas can be nitrogen or a noble gas, e.g. argon. In some embodiments, film-forming apparatus 500 can also include solvent trap 230. Purge gas source 555 and vacuum source 235 induce a gas flow 540 along a flow path extending through the vicinity of, and substantially parallel to, vaporization region 505 and through evacuation port 520 sufficient to entrain and remove carrier liquid vapor 215 located at or proximate to vaporization region 505. Vaporization region 505 can be part of an apparatus for depositing an organic material as a film, such as an organic light-emitting diode film, onto a substrate. Vaporization region 505 can be an unpatterned surface, or can contain micro-patterned surface features, such as micropores, micro-pillars, micro-channels that extend from a first opening through transfer member 503 to a second opening formed on a second opposing face of the transfer member, or other micro- or nano-patterned structures, and may further include arrays of such structures (interchangeably, micro-arrays).

Ink 210 is received onto vaporization region 505. Vaporization region 505 can then be heated sufficiently to vaporize the carrier liquid in ink 210, thus forming carrier liquid vapor 215 proximate to vaporization region 505 and ink 210. Ink 210, which after evaporation consists essentially of its constituent solid material, can then be discharged in a subsequent step. In some embodiments, vaporization region 505 can be a solid or substantially solid surface, as shown. Alternatively in other embodiments, vaporization region 505 can have a series of channels or be otherwise permeable to ink 210 so that ink 210 passes through transfer member 503 and is transferred in the direction opposite to that from which it was originally deposited. Evacuation port 520 and purge gas port 525 are located in proximity to and on opposite sides of vaporization region 505 and in or near to the plane defined by vaporization region 505. Gas flow 540 over vaporization region 505 and ink 210 serves to draw carrier liquid vapor 215 away from the proximity of ink 210 and vaporization region 505, and to evacuation port 520, and thus to vacuum source 235 or to solvent trap 230 if present. This reduces or eliminates the likelihood of carrier liquid vapor 215 from escaping or returning to vaporization region 505 or other part of the film-forming apparatus, thereby greatly reducing or eliminating recondensation of carrier liquid vapor 215 on any part of the film-forming apparatus and reducing or eliminating contamination of the desired final film by the carrier liquid.

Considerations that are noteworthy in tuning performance of this embodiment include the distances between the ports and the ink, the diameters of the ports, and the gas flow rate. In various embodiments, ink drop 210 can have a diameter of up to 200 micrometers, and typically from 10 to 100 micrometers. The diameters of evacuation port 520 and purge gas port 525 should be from 50 to 300 micrometers. Separation distance 565 is the distance between the centers of the ports and the center of ink 210, and should be from 100 to 200 micrometers. The gas flow rate is sufficient to prevent carrier liquid vapor molecules from escaping or returning to vaporization region 505 or other part of the film-forming apparatus, while not being so great as to disrupt the film-forming process, e.g. by distorting ink drop 210 before the carrier liquid evaporates. The gas flow rate can be in the range of from 0.03 to 1.5 standard liters per minute, and usefully in the range of from 0.1 to 0.8 standard liters per minute.

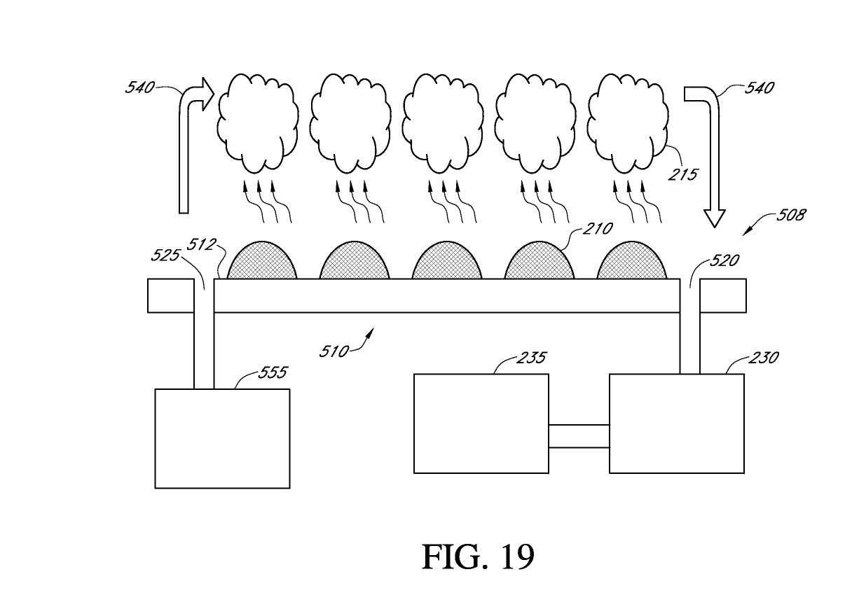

FIG. 19 schematically illustrates a solvent vapor removal apparatus that is part of a film-forming apparatus 508 according to another embodiment of this disclosure. FIG. 19 illustrates a variation of the embodiment of FIG. 18, wherein transfer member 510 is designed to accept and transfer a multiplicity of ink drops 210 arranged in an array. In this embodiment, evacuation port 520 and purge gas port 525 are located outside of an array of ink drops 210. Evacuation port 520 and purge gas port 525 can be single ports or a linear array of ports, and can be circular or elongated, and that the choice of shape and number of ports will depend upon the shape and size of the array of ink drops from which carrier liquid is to be removed. The transfer surface 512 of transfer member 510 is defined as the area designed to accept and transfer ink drops 210. Transfer surface 512 can be heated to vaporize the carrier liquid of ink drops 210 as vaporized carrier liquid 215. Evacuation port(s) 520 and purge gas port(s) 525 are placed such that gas flow 540 is directed over ink drops 210 so as to sweep vaporized carrier liquid 215 to evacuation port 520. This reduces or eliminates the likelihood of carrier liquid vapor 215 from escaping or returning to vaporization region 512 or other part of the film-forming apparatus, thereby greatly reducing or eliminating recondensation of carrier liquid vapor 215 on any part of the film-forming apparatus and reducing or eliminating contamination by the carrier liquid in the desired final film. The gas flow rate can be in the range of 0.03 to 1.5 standard liters per minute per ink drop, and usefully in the range of 0.1 to 0.8 standard liters per minute per ink drop. Evacuation port 520 and gas purge port 525 are sized as taught herein to allow the desired gas flow rate.

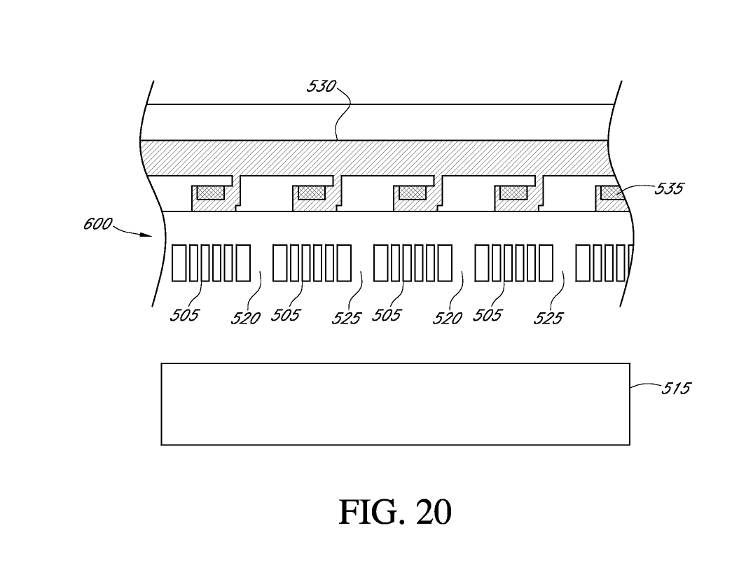

FIG. 20 schematically illustrates a solvent vapor removal apparatus that is part of a film-forming apparatus according to various embodiments of this disclosure wherein the solvent vapor removal apparatus comprises multiple units of the solvent vapor removal apparatus of FIG. 18 integrated with multiple vaporization regions of a larger film-forming apparatus. Film-forming apparatus 600 comprises multiple evacuation ports 520, multiple purge gas ports 525, and multiple vaporization regions 505, and is an apparatus for depositing an organic material as a film onto a substrate. Each vaporization region 505 is defined at least in part by a respective surface portion of a transfer member wherein each respective surface portion is disposed along a first plane. Film-forming apparatus 600 can be an apparatus for depositing an OLED film onto a substrate, as disclosed in the U.S. Patent Application Publications referenced herein. Film-forming apparatus 600 can comprise a one-dimensional array of vaporization regions 505 and associated evacuation ports 520 and purge gas ports 525, as shown, or a two-dimensional array of vaporization regions 505 and associated evacuation ports 520 and purge gas ports 525. The array can include any number of vaporization regions 505, and can be in any pattern desirable, e.g., square, rectangular, circular, triangular, chevron-shaped, or other desirable shape.

Evacuation ports 520 and purge gas ports 525 can be placed between vaporization regions 505 in an alternating pattern in a row, or placed between rows of vaporization regions 505 in a two-dimensional array, or both. Vaporization regions 505 are configured to each support a respective portion of film-forming material in a carrier liquid, e.g., ink as defined herein. The multiple evacuation ports 520 are in communication with a vacuum source via a manifold (not shown for clarity), and the multiple purge gas ports 525 are in communication with a purge gas source via a second manifold (not shown), to provide a flow of gas from purge gas ports 525 along flow paths extending through the vicinity of, and substantially parallel to, vaporization regions 505, and through evacuation port 520. The gas flow is sufficient to entrain and remove carrier liquid vapor located at or proximate to vaporization regions 505. The apparatus can also include a solvent trap in some embodiments, as disclosed above. In some embodiments of this disclosure, the diameter of evacuation ports 520 and the separation distance between evacuation ports 520 and vaporization regions 505 are on the same order of magnitude as the diameter of the ink drop, and the gas flow rate is from 0.03 to 1.5 standard liters per minute per ink drop, as disclosed above.

Ink from ink reservoirs 530 is deposited by ink deposition systems 535 onto the respective vaporization regions 505. In the apparatus of FIG. 20, vaporization regions 505 have channels or are otherwise permeable to ink. Vaporization regions 505 can then be heated sufficiently to vaporize the carrier liquid in the ink, thus forming carrier liquid vapor above vaporization regions 505 and the ink. The ink, which after evaporation consists essentially of its constituent solid material, can be discharged in a subsequent step, e.g., onto substrate 515. The gas flow from purge gas ports 525 to evacuation ports 520 causes a flow of gas over vaporization regions 505 and entrains carrier liquid vapor into evacuation ports 520 before any recondensation of the carrier liquid vapor can take place. Substantial removal of the carrier liquid vapor can substantially reduce or eliminate the problems of carrier liquid vapor recondensing onto film-forming apparatus 600 and being co-deposited with the film-forming solid portion of the ink.

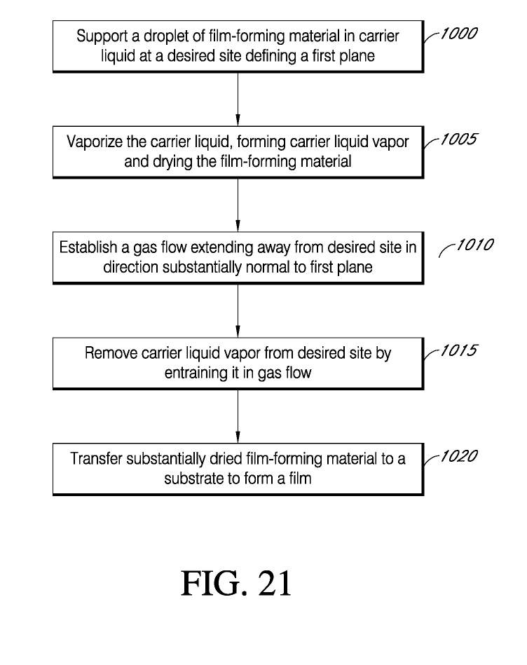

FIG. 21 is a flow diagram that illustrates a method for forming a film according to various embodiments of the present teachings. FIG. 21 can be understood in light of various apparatus embodiments described herein, for example, in connection with FIG. 8. In step 1000, a quantity of a film-forming material in a carrier liquid (ink) is received at and supported by a desired site (vaporization region). The desired site defines a first plane. In step 1005, the ink is heated, which vaporizes the carrier liquid, forming carrier liquid vapor in the vicinity of the site and substantially dry film-forming material. In step 1010, a gas flow is established along a path that extends away from the vicinity of the site, wherein the gas flow path follows a line substantially normal to the first plane. In step 1015, the gas flow entrains the carrier liquid vapor, thereby removing from the vicinity of the site. In step 1020, the film-forming material, which is now substantially dried, is transferred to a substrate, thereby forming a film.

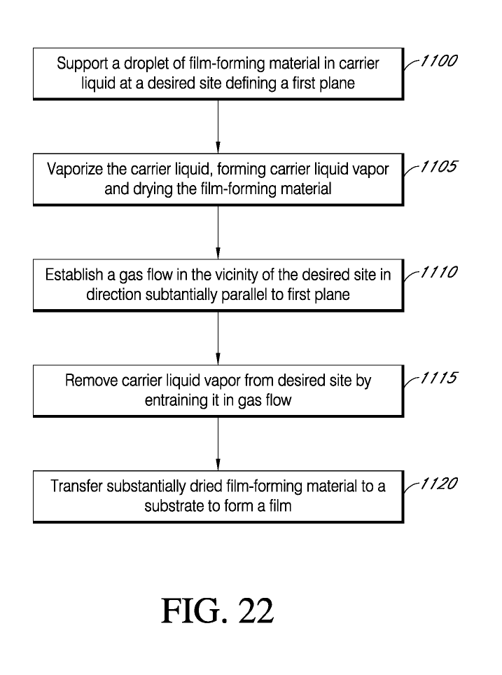

FIG. 22 is a flow diagram that illustrates a method for forming a film according to various embodiments of the present teachings. FIG. 22 can be understood in light of various apparatus embodiments described herein, for example, in connection with FIG. 18. In step 1100, a quantity of a film-forming material in a carrier liquid (ink) is received at and supported by a desired site (vaporization region). The desired site defines a first plane. In step 1105, the ink is heated, which vaporizes the carrier liquid, forming carrier liquid vapor in the vicinity of the site and substantially dry film-forming material. In step 1110, a gas flow is established along a path in the vicinity of the site, wherein the gas flow path follows a line substantially parallel to the first plane. In step 1015, the gas flow entrains the carrier liquid vapor, thereby removing from the vicinity of the site. In step 1020, the film-forming material, which is now substantially dried, is transferred to a substrate, thereby forming a film.

### EXAMPLES

The following examples are given to illustrate the nature of the present teachings. It should be understood, however, that the present teachings are not to be limited to the specific conditions or details set forth in these examples.

### Example 1

This example demonstrates the superior benefits of the present teachings. A 3-inch air knife from Exair Corporation (Cincinnati, Ohio) was connected to a nitrogen gas source and used in an open glove box. The air knife was mounted such that nitrogen gas emitting from the air knife was at the height of a top surface of a chuck holding a substrate. The air knife was located approximately 10 inches in distance away from the substrate. The substrate was previously prepared with an electronic circuitry layer, a whole injection layer, and a whole transfer layer, as well as intermediate baking steps. Inkjet printing was performed on the substrate in both an in-pixel and the cross-pixel configuration in respective regions of the substrate. For each pass of the inkjet printhead over the substrate, 120 nozzles were employed with an allowance of 10 nozzles per pixel, although only the first five nozzles per pixel were utilized. For each particular region, two passes of the inkjet printhead across the substrate were performed. The inkjet printing of the substrate took place in a glove box filled with air. The chuck holding the substrate was maintained at room temperature, or about 25.3° C. The nitrogen gas was emitted from the air knife at a pressure of 10 psig. A total of seven tests were performed on the primed glass panel corresponding to the substrate. The regions or test sections of the panel were designated T1 through T7. T1 was a test serving as a control in which the air knife was turned off. Test sections T2 through T4 were cross-pixel orientations. Test sections T5 through T7 were in-pixel orientations. For both the cross-pixel and in-pixel orientation tests, there was a test in which the air knife was turned on only after the first pass of the inkjet printhead, one of which had the air knife on at all times, and one test in which the air knife was only turned on after the second pass of the inkjet printhead. The results of the tests T1 through T7 are shown in Table 1. As is apparent, leaving the air knife on at all times gave the best results as no pile-up of ink occurred in pixel banks. The 40/60 designation for T5 indicates that approximately 60% of the pixel bank experienced pile-up of the applied ink. The ink applied to the substrate in the test was a G24 ink

TABLE 1

| | AK | AK Pressure | | |
|---|---|---|---|---|
| Test Section | Location | (psi) | AK Condition | Note |
| 1 | NA | OFF | NA | Pile-up |
| 2 | A | 10 | Post 1st Pass | Pile-up |
| 3 | A | 10 | Always ON | NO Pile-up |
| 4 | A | 10 | Post 2nd Pass | Pile-up |
| 5 | B | 10 | Post 1st Pass | 40/60 Pile-up |
| 6 | B | 10 | Always ON | NO Pile-up |
| 7 | B | 10 | Post 2nd Pass | Pile-up |

### Example 2

This example demonstrates the superior benefits of the present teachings. A substrate similar to that used in Example 1 was again printed with an ink using an inkjet printhead. In this experiment, the inkjet printhead was paired with a vacuum orifice that was connected to the inkjet printhead such that movement of the inkjet and vacuum orifice moved in tandem during printing of the substrate. The substrate was divided into 14 regions corresponding to 14 different test conditions. In each region, two inkjet printing passes were performed with the second inkjet print pass being adjacent to the first inkjet printhead pass. In the various test conditions, a vacuum was either applied or not applied, and the air knife was either applied or not applied. When an air knife was applied, it was used to blow nitrogen across the substrate in a cross-pixel configuration. The following test conditions were employed: A control test condition in which both the vacuum and air knife were turned off, an air knife using 5 psig of nitrogen gas, an air knife using 10 psig of nitrogen gas, an air knife using 15 psig of nitrogen gas, an air knife using 12 psig of nitrogen gas, an air knife using 25 psig of nitrogen gas, an air knife using 30 psig of nitrogen gas, a vacuum and an air knife using 2 psig of nitrogen gas, a vacuum and an air knife using 5 psig of nitrogen gas, a vacuum and an air knife using 10 psig of nitrogen gas, a vacuum on high power used alone, a vacuum on medium power used alone, a vacuum on medium/high power used alone, and a vacuum used alone on small power. The results of this experiment indicated that using the air knife pressure up to 30 psig alone without vacuum worked well. The use of the vacuum alone gave results that looked worse than the use of the air knife alone. A vacuum at medium/high power appeared to be the most promising. The application of a vacuum in combination with the air knife can cause the emitting layer (EML) ink to move outside of the pixel banks.

### Example 3

This example demonstrates the superior benefits of the present teachings. In this experimental setup, an air knife with a 9-inch long aperture was used to emit nitrogen gas at a uniform velocity across a substrate at a velocity of 2.9 m/s in a cross-pixel configuration. The air knife was mounted and positioned similar to that described in Example 1 at a distance of about 10 inches from the substrate. Inkjet printing was performed in various regions along the length of the substrate. The inkjet printing was performed across the entire width of the substrate for each of these printing runs, again, each one being performed with a first pass and a second pass of the inkjet printhead. Each of these test regions involved inkjet printing in which the air knife was always turned on with a pressure of 10 psig. A control region that only spanned approximately half the width of the substrate was also printed but without the air knife on. Adjacent to that control region, the other approximately other half of that width, a partial control in which the air knife was turned on only after a first pass of inkjet printing was performed. The control region showed pile-up of the deposited ink in the various pixel banks. In all the test regions across the entire width of the substrate in which the air knife was always turned on, no pile-up was observed.

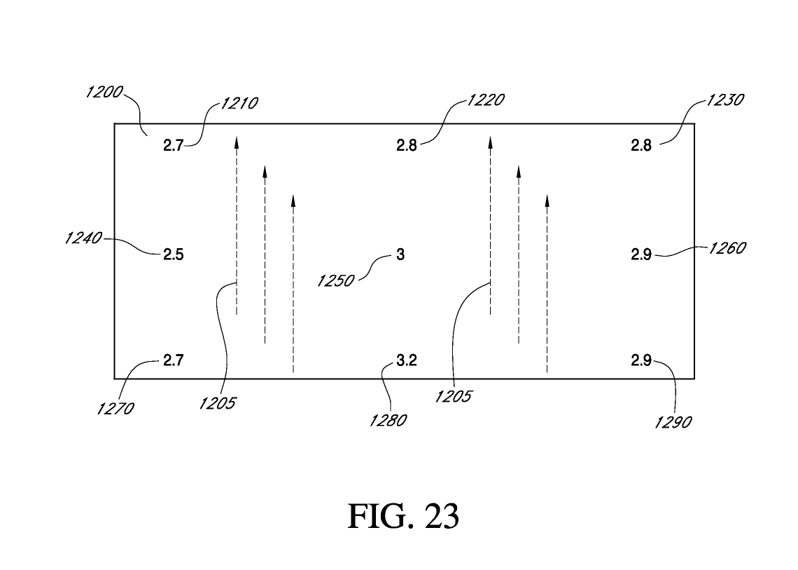

FIG. 23 is a schematic representation of a substrate 1200 to which an air knife having a 9-inch aperture length was aligned and nitrogen gas was blown across the substrate. This test was performed in both an open glove box environment that was open to the ambient air and in a closed glove box comprising a nitrogen gas atmosphere. In both tests the air knife emitted nitrogen gas at a pressure of 10 psig. The dashed arrows 1205 in FIG. 23 indicate the direction of the flow of the nitrogen gas from the air knife. At 9 different locations, 1210, 1220, 1230, 1240, 1250, 1260, 1270, 1280, and 1290, the speed of the nitrogen gas over the substrate was measured. Essentially the same values for nitrogen gas speed were detected when employing the air knife in the open-air atmosphere and in the closed nitrogen gas atmosphere. The values shown in the various locations in FIG. 23 are in m/s. An average nitrogen gas speed of 2.8 m/s was measured in both the open-air environment and in the nitrogen gas closed glove box environment.

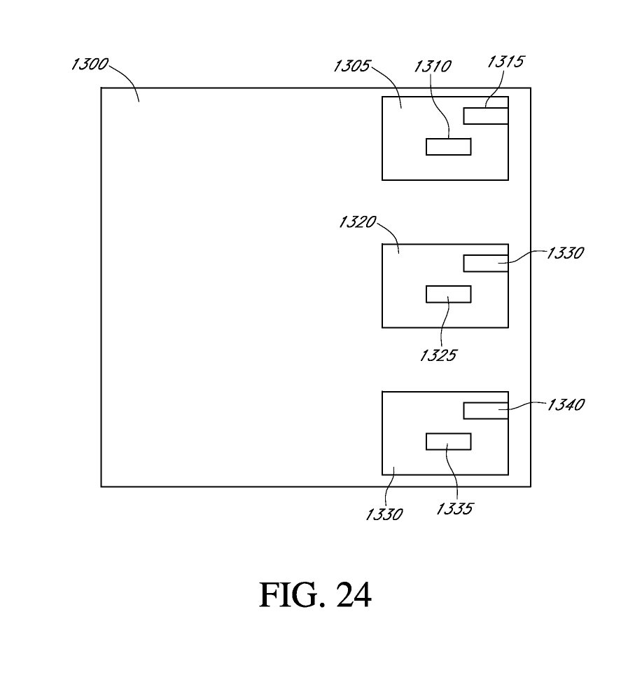

FIG. 24 shows a schematic diagram of a substrate 1300 and three different 10×10 pixel regions 1305, 1320, and 1330, in which drying time of ink in various pixel banks was investigated using the same 9-inch air knife using a nitrogen source, or blowing nitrogen across the substrate during inkjet printing. In all three regions, a pixel at the center of the region and a pixel toward the edge of the region were observed for the amount of time it took for the ink to dry in the various pixels. Region 1305 served as a control where the air knife was turned off. In region 1305, a drying time of 45 seconds was observed at center pixel 1310, and a drying time of 26 seconds was observed in edge pixel 1315. This corresponded to a difference in drying time between the edge and the center of 19 seconds. In region 1320, the air knife was turned on with nitrogen gas being emitted at a pressure of 10 psig. Drying was observed to take 18 seconds at center pixel 1325, and 15 seconds at edge pixel 1330. Those drying times corresponded to a difference of only 3 seconds. In region 1330, a pressure of 5 psig of nitrogen gas emitted from an air knife was used. At center pixel 1335, a drying time of 20 seconds was measured, and in edge pixel 1340, a drying time of 17 seconds was observed. Again, a difference of only 3 seconds in drying time was observed between the center and the edge.

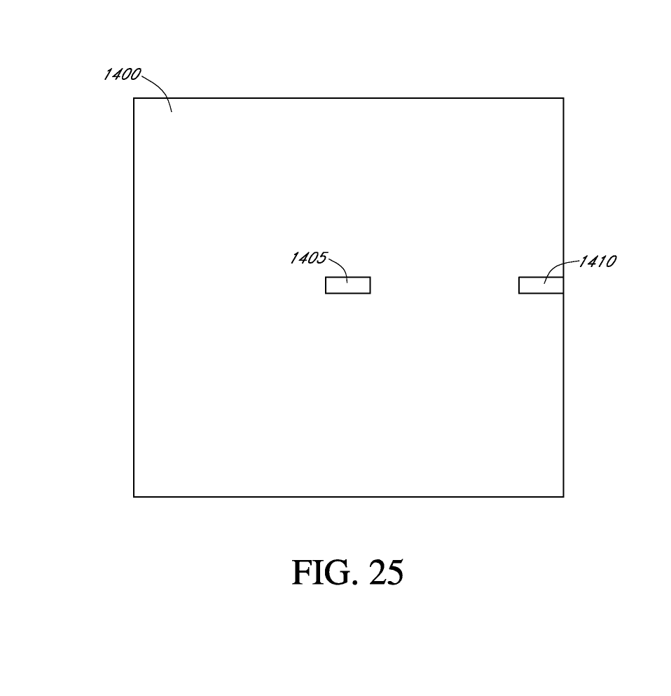

FIG. 25 shows a schematic diagram of a substrate 1400 that was printed across the entire surface of the substrate at various pixel bank locations, including center pixel 1405 and edge pixel 1410. Printing was performed with the air knife on using 20 psig of nitrogen gas, and the test was also performed as a control with no use of the air knife By using the air knife, a drying time of less than 31 seconds was observed at pixel 1405, compared to 110.3 seconds without the air knife. At edge pixel 1410, a drying time of 22 seconds was observed when using the air knife, and a drying time of 42.7 seconds was observed when the air knife was not used. Use of the air knife made a difference in drying time of only about 9 seconds compared to a difference in drying time of about 68 seconds when the air knife was not used. These results show the utility of using an air knife to achieve a relatively constant drying time, which allows for more rapid processing of printed substrates.

### Example 4

This example demonstrates the superior benefits of the present teachings. In this experimental setup, an air knife was not used. Instead of using an air knife, two fans were used. The two fans were mounted adjacent to the inkjet printhead in such a manner that the two fans moved in tandem with inkjet printhead during printing. A dual electric fan hardware setup was used to test if a more localized drying or solvent cloud disruption would give a similar result to that observed with the gas knife experiments. The two fans were purchased off the shelf and wired in parallel to a variable 12V power supply. They were clamped onto the print station with a C-clamp. Each of the two fans had a maximum air flow of 8.5 CFM, a noise level of 30 dBA, a size of 40 mm×40 mm×20 mm, a single ball bearing, and a speed of 7200 RPM. The printing took place on a substrate similar to that used in Example 1. The printing was performed in a closed glove box in a nitrogen gas environment. The voltage applied to the fans was varied to achieve a velocity range of approximately 1.4 m/s to approximately 3.8 m/s. Table 2 shows the voltages employed during various tests and the corresponding velocity of the nitrogen gas blown by the fans. A control was also performed in which the fans were turned off. In the control situation, pile-up in the various pixel banks occurred. With all the test conditions in which the fans were on, no pile-up of ink occurred. These results were similar to those described in the other examples using an air knife

TABLE 2

| | Velocity |
|---|---|
| Voltage | (m/sec) |
| 12 V | 3.6 |
| 11 V | 3.1 |
| 10 V | 2.7 |
| 9 V | 2.5 |
| 8 V | 2.1 |
| 7 V | 1.8 |
| 6 V | 1.4 |
| 5 V | 0.8 |

All publications, patents, and patent applications mentioned in this specification are herein incorporated by reference to the same extent as if each individual publication, patent, or patent application was specifically and individually indicated to be incorporated by reference.

While embodiments of the present teachings have been shown and described herein, it will be obvious to those skilled in the art that such embodiments are provided by way of example only. Numerous variations, changes, and substitutions will now occur to those skilled in the art without departing from the present teachings. It should be understood that various alternatives to the embodiments of the present teachings described herein may be employed in practicing the teachings.

What is claimed is:

1. A substrate printing system comprising:
a chuck comprising a top surface configured to hold a substrate;
an inkjet printhead configured for inkjet printing onto the substrate; and
a gas knife comprising an inlet for receiving pressurized gas from a pressurized gas source, and an outlet slot having a length and being configured to direct pressurized gas from the gas knife in a sheet flow toward a substrate held by the chuck.

2. The substrate printing system of claim 1, wherein the inkjet printhead is in fluid communication with a supply of ink and the ink comprises a carrier fluid and film-forming organic material dissolved or suspended in the carrier fluid.

3. The substrate printing system of claim 1, further comprising a substrate held by the chuck, wherein the substrate comprises at least two rows of pixel banks, each pixel bank being configured to fence-in organic material for forming a pixel, each row having a length, each pixel bank having a length and a width that is shorter than the length, the lengths of the pixel banks in each row are arranged substantially perpendicular to the length of the respective row, and the length of the outlet slot is oriented substantially parallel to the length of each pixel bank and substantially perpendicular to the length of each row.

4. The substrate printing system of claim 1, further comprising a substrate held by the chuck, wherein the substrate comprises at least two rows of pixel banks, each pixel bank being configured to fence-in organic material for forming a pixel, each row having a length, each pixel bank having a length and a width that is shorter than the length, the lengths of the pixel banks in each row are arranged substantially perpendicular to the length of the respective row, and the length of the outlet slot is oriented substantially perpendicular to the length of each pixel bank and substantially parallel to the length of each row.

5. The substrate printing system of claim 1, further comprising an evacuation port and a vacuum source in fluid communication with the evacuation port, wherein the evacuation port is positioned relative to the gas knife such that a sheet flow of gas produced by the gas knife is sucked away through the evacuation port

6. The substrate printing system of claim 5, wherein the evacuation port is mounted adjacent to the inkjet printhead and the evacuation port and the inkjet printhead are configured to move in tandem relative to the top surface of the chuck.

7. The substrate printing system of claim 1, further comprising a substrate positioned on the top surface of the chuck, the substrate comprising a top surface, a lateral edge, a length, and a width, wherein the gas knife is spaced from the lateral edge by a first distance, the first distance is at least twice the length of the substrate, and the length of the substrate is substantially perpendicular to the length of the outlet slot.

8. The substrate printing system of claim 7, wherein the first distance is at least twice the width of the substrate and the width of the substrate is substantially perpendicular to the length of the outlet slot.

9. The substrate printing system of claim 1, further comprising an enclosure containing the chuck, the inkjet printhead, and the gas knife, and the enclosure comprises a nitrogen gas inert atmosphere.

10. The substrate printing system of claim 1, further comprising a printhead actuator configured to move the inkjet printhead relative to the chuck during printing onto a substrate held by the chuck.

11. The substrate printing system of claim 1, further comprising at least one actuator configured to move the chuck and the gas knife relative to the inkjet printhead during printing onto a substrate held by the chuck.

12. A method for obtaining a substantially uniform distribution of a film-forming organic material in pixel banks formed on a substrate, the method comprising:
holding a substrate with a chuck, the substrate comprising a plurality of pixel banks formed on a print surface of the substrate;
directing a sheet flow of gas from an outlet slot of a gas knife toward the substrate held by the chuck, and the outlet slot having a length;
printing an inkjet ink from a first inkjet printhead onto a first plurality of the pixel banks formed on the substrate; and
printing an inkjet ink from a second inkjet printhead onto a second plurality of the pixel banks formed on the substrate,
wherein the sheet flow of gas facilitates an even distribution of the inkjet ink within each pixel bank and prevents pile-up of inkjet ink within each pixel bank.

13. The method of claim 12, wherein the sheet flow of gas is directed toward the substrate during the printing onto both of the first plurality and the second plurality of pixel banks.

14. The method of claim 12, wherein the sheet flow of gas is directed from the gas knife at a pressure of from about 1.0 psig to about 25 psig.

15. The method of claim 12, wherein the print surface of the substrate comprises at least two rows of pixel banks, each row has a length, each pixel bank has a length and a width that is shorter than the length, the length of each pixel bank is arranged substantially perpendicular to the length of its respective row, and the outlet slot of the gas knife has a length that is substantially parallel to the length of each pixel bank and substantially perpendicular to the length of each row.

16. The method of claim 12, wherein the print surface of the substrate comprises at least two rows of pixel banks, each row has a length, each pixel bank has a length and a width that is shorter than the length, the length of each pixel bank is arranged substantially perpendicular to the length of its respective row, and the outlet slot of the gas knife has a length that is substantially perpendicular to the length of each pixel bank and substantially parallel to the length of each row.

17. The method of claim 12, further comprising applying a vacuum through an evacuation port to suck up the sheet flow of gas after the sheet flow of gas is directed toward the substrate.

18.-24. (canceled)

25. An apparatus for drying a film-forming material in a carrier liquid, comprising:
a transfer member for receiving the film-forming material in the carrier liquid, and depositing dried film-forming material onto a substrate;
a vaporization region defined at least in part by a surface portion of the transfer member, wherein the surface portion is disposed along a first plane, and further wherein the vaporization region is configured to support a portion of the film-forming material in the carrier liquid;
a heater adapted to heat the vaporization region;
an evacuation port adjacent the vaporization region and intersecting a line extending away from the vaporization region, substantially normal to the first plane; and
a vacuum source adapted for fluid communication with the evacuation port;
whereby, in operation, the vacuum source induces a gas flow extending from the vaporization region through the evacuation port sufficient to entrain and remove vapor located at or proximate to the vaporization region.

26. The apparatus of claim 25, further comprising an array of evacuation ports adjacent the vaporization region and intersecting a line extending away from the vaporization region substantially normal to the first plane, wherein the evacuation port is a part of the array of evacuation ports, the vacuum source is adapted for fluid communication with the array of evacuation ports, and, in operation, the vacuum source induces a gas flow extending from the vaporization region through the array of evacuation ports and of sufficient flow to entrain and remove vapor located at or proximate to the vaporization region.

27. The apparatus of claim 25, further comprising:
a purge gas port adjacent the vaporization region and located in the first plane on a side of the vaporization region opposite the evacuation port; and
a purge gas source adapted for fluid communication with the purge gas port;
wherein, in operation, the purge gas source and the vacuum source induce a gas flow along a flow path extending through the vicinity of, and substantially parallel to, the vaporization region and through the evacuation port, and of sufficient flow to entrain and remove vapor located at or proximate to the vaporization region.
